(19) United States
(12) Patent Application Publication
(10) Pub. No.: US 2017/0365185 A1
(43) Pub. Date: Dec. 21, 2017

(54) COMPUTERIZED SYSTEM AND METHOD FOR DETERMINING LEARNING STYLES DURING ONLINE SESSIONS AND PROVIDING ONLINE FUNCTIONALITY BASED THEREFROM

(71) Applicant: GLEIM CONFERENCING, LLC, Gainesville, FL (US)

(72) Inventors: Garrett W. Gleim, Gainesville, FL (US); Bradley D. Patterson, Palm Beach Gardens, FL (US)

(21) Appl. No.: 15/695,759

(22) Filed: Sep. 5, 2017

Related U.S. Application Data
(63) Continuation of application No. 14/692,540, filed on Apr. 21, 2015.
(60) Provisional application No. 61/982,572, filed on Apr. 22, 2014.

(51) Int. Cl. G09B 19/00; G09B 7/04

(52) U.S. Cl. CPC G09B 19/00; G09B 7/04

(57) ABSTRACT

A process and system for incentivizes students by generating and displaying a scoring system that helps that student and other students study is disclosed. One embodiment is a computer implemented process that includes displaying to a student one or more virtual student classrooms via a computing device connected to a display; permitting the student to select via an input device connected to the computing device one of the virtual student classrooms to enter; showing the student entering the selected one of the virtual student classrooms; observing the students study together in a study session in the selected virtual student classroom; and grading each student in the study session according to predetermined performance criteria.

### CROSS REFERENCE TO RELATED APPLICATIONS

This application is a continuation of U.S. patent application Ser. No. 14/692,540, filed Apr. 21, 2015, entitled Learning Styles and Virtual Study Groups Gamification System and Method, which claims the benefit of priority of U.S. Provisional Patent Application Ser. No. 61/982,572, filed Apr. 22, 2014, the content of which is hereby incorporated by reference in its entirety.

### BACKGROUND OF THE DISCLOSURE

With the invention of Multidimensional Virtual Learning System and Method (Non-Provisional patent application Number: U.S. patent application Ser. No. 14/460,575, filed Aug. 15, 2014), students will be learning together in an online virtual environment that closely resembles the physical world. While the physics of sound and the virtual association of physically sitting at a conference room table or classroom in the virtual world is very similar to the physical world, the virtual study environment will also mirror the physical world in that some students will be more helpful, more knowledgeable, more mature, and/or more professional than other students. One solution to get students to work together is to have students group themselves by learning style. Some students study in one manner and other students excel studying in other manners. Because some styles clash or do not work well together, it is important to devise a system and/or method for students to learn (or discover) what their learning style is and to disseminate that information to other students within the study group. This allows students to group themselves with students who have similar learning styles. In addition, by allowing students to grade or score each other based on how well each student helps other students learn, it can make education more efficient and potentially less expensive.

Ferrell in U.S. Pat. No. 6,285,993 has developed a system to identify students' learning styles. However, this system requires “presenting one or more displays”, “selecting factors from various categories using graphics and written text”, among many other time consuming tasks to try and identify or determine a learning style. Unfortunately, the Millennial Generation is not going to take the time to complete all of Ferrell's tasks. Moreover, feedback from multiple users may provide more data points that can be used to ascertain or identify a student's or teacher's learning styles than a protracted self-examination.

Greene et al. in U.S. Pat. No. 6,782,396 developed a method for aligning students' learning styles with teacher's teaching styles. This method has several drawbacks in today's educational environment. For example, first, the concept of teaching style can be nebulous. What is really more important is how does the teacher learn because people with similar learning styles will typically learn quicker and more efficiently when grouped together. As a second example, personal preferences can be superior to a programmed or static algorithm that places students in a class based on its outcome without consulting the student. It is usually better to provide information to the student and allow the student to choose the people he or she desires to study with. There is not a one-size fit all formula and by providing the power of choosing a teacher to the student, the matching is often superior to any “calculating” algorithm. Third, by having students and teachers grade each other, there can be more data than any single test or single user input can provide the system or method when it comes to anyone's learning style.

Therefore, currently there is no system or method that allows students to become aware of their learning style and then make choices of whom to study with based on other students' learning styles or even their professor's learning style. Furthermore, there currently is no system that encourages, enables, and facilitates students to monitor their behaviors while also rewarding students who perform better at helping other students.

### SUMMARY OF THE DISCLOSURE

The system and method presently disclosed solves several issues, such as: 1) it can help students find other participating students who learn in the same or similar manners, 2) when students interact with other students who learn in a different manner, they can understand their learning style differences and not necessarily become irritated with or penalize students with other learning styles when they score these other students under the presently disclosed system, 3) it can allow students to find teachers and tutors who have similar learning styles, and 4) by incentivizing students to be helpful, mature, knowledgeable and professional when studying with each other, it can help students learn quicker and more efficiently, thereby lowering the cost of education.

An exemplary embodiment of a process in accordance with the present disclosure includes operations of: displaying one or more virtual student classrooms via a computing device to a student; permitting the student to select one of the student classrooms to enter; the student entering the selected one of the student classrooms; confirming, by observing a study session, that the student and one or more other students study together in the study session in the selected virtual classroom; and grading each student in the study session according to predetermined performance criteria. In this embodiment, the student grades each other student participating in the study session in the selected virtual classroom. In another embodiment, the grading is done after the study session. In another embodiment, the grading is done by an outside observer of the study session. In another embodiment, the grading is done by each student participating in the study session in the selected virtual classroom after leaving the classroom. The system according to this disclosure includes means for performing each of the operations described above.

The process may also include displaying a grade score to the student when displaying the one or more virtual classrooms to the student for selection of a virtual classroom to enter. The predetermined criteria may include one or more of helpfulness, maturity, professionalism and knowledge level. Furthermore, the grading may be based on a predefined scale of 0 to 5 with 0 being lowest performance and 5 highest, for example. Alternatively, the grading may be on any predefined scale, for example a scale of 1 to 10 with 1 being the highest and 10 the lowest. In yet another variation, questions can be binary (e.g., a checkbox style) questions.

The process may include having each student grade each other student in the study session after leaving the virtual classroom. The process may also include compiling scores for each student and generating an average for the student and an average for the study session. Furthermore, such generating may also involve displaying a mode, median, mean and/or standard deviation for the scores being compiled.

A process in accordance with the present disclosure may include operations of: displaying one or more virtual student classrooms via a computing device to a student; permitting the student to select one of the student classrooms to enter; the student entering the selected one of the student classrooms; displaying to the student images representing the students in the selected student classroom; observing the students as they study together in a study session in the selected virtual classroom; and grading each student in the study session according to predetermined performance criteria.

The student may grade each other student participating in the study session in the selected virtual classroom. The grading may alternatively be done after the study session. The process grading may also be done by an outside observer of the study session or by each student participating in the study session in the selected virtual classroom after leaving the classroom. The process may include displaying a classroom grade score to the student when displaying the one or more virtual classrooms to the student for selection of a virtual classroom to enter. The predetermined criteria can include one or more of helpfulness maturity, professionalism and knowledge level. Furthermore, the grading can be based on a predefined scale, such as 0 to 5 with 0 being lowest performance and 5 highest. The process can include compiling scores for each student and generates an average for the student and an average for the study session.

An exemplary embodiment of the present disclosure may be implemented on a server-client computer system or distributed server-client computer system. Thus one exemplary embodiment may be viewed as a computer implemented process that includes operations of transmitting, via a server to a display device on a client device for display to a student one or more virtual student classrooms; receiving from the client device a selection by the student of one of the virtual student classrooms to enter; transmitting via the server to the client device an image of the student entering the selected one of the virtual student classrooms for display on the client device; determining via the server that the student and one or more other students study together in a study session in the selected virtual student classroom and grading, via the server each other student in the study session according to predetermined performance criteria. The process may further include transmitting, via the server to the client device for display to each of the students a grade associated with the study session in the virtual classroom.

The process may alternatively include the server receiving from the client device a grade provided by each student according to the predetermined performance, and the server thereafter transmitting to the display device on the client device for display to each student the grade provided by each other student. Other features and advantages of embodiments of the present disclosure will become apparent to a reader of the following Detailed Description when taken in conjunction with the accompanying drawings.

### BRIEF DESCRIPTION OF THE DRAWINGS

FIG. 1 is a flowchart of one embodiment of the process for a scoring system incorporating learning style function when gamification occurs at a point in time after each individual student leaves the study room.

FIG. 2 is a more detailed flowchart of one embodiment of the process for a scoring system incorporating learning style function when gamification occurs at a point in time after each individual student leaves the study room.

FIGS. 3A-3B is a flowchart of one embodiment of the process for a scoring system incorporating learning style function when gamification occurs at the time each student leaves the study room.

FIGS. 4A-4B is a flowchart of one embodiment of the process for a scoring system for the administrator to score the students while seeing or knowing the students' learning styles. Moreover, this embodiment allows students to choose the professor or administrator by learning style.

FIG. 5 is an embodiment of the learning style function process.

FIG. 6 is an embodiment of the method/process of generating a student's learning style.

FIG. 7 is an embodiment of the method/process of evaluating learning style results and generating a score for each learning style.

FIG. 8 is an exemplary example of a database for learning style and gamification analysis.

FIGS. 9A-9B is an embodiment for the method/process for determining suggested learning styles.

FIG. 10 is a representation of a client device utilized in an embodiment of the process of the present disclosure.

FIG. 11 is a block diagram of a system utilizing an embodiment of the present disclosure.

FIG. 12 is an exemplary diagram of how a student's learning style could be displayed in a graphical depiction.

FIG. 13 is an exemplary diagram of how a student's learning style could be displayed to a student in a pictorial form.

FIG. 14 is an exemplary diagram of how a student's learning style could be displayed after a student took the Learning Style Questionnaire.

FIG. 15 is an exemplary diagram of how a student's learning style could be displayed after a student took the Learning Style Questionnaire.

FIG. 16 is an exemplary diagram of how a student's learning style could be displayed after a student took the Learning Style Questionnaire.

FIG. 17 is an exemplary diagram of how a student's learning style could be displayed after a student took the Learning Style Questionnaire.

FIG. 18 is an exemplary visual representation of how a learning style is selected using the process as shown in process operation 795 in FIG. 7.

FIG. 19 is an exemplary screen shot of an example of study rooms.

FIG. 20 is an exemplary screen shot of a display of students' scores in a study room.

FIG. 21 is an exemplary screen shot for display of students' abbreviated scores in a study room.

FIG. 22 is an embodiment of the method/process of compiling information and creating statistics of each respective student's or user's Criterion Categories.

FIG. 23 is an embodiment of the method/process to refine a user's learning style based on feedback from other users.

FIG. 24 is an embodiment of the method/process to refine a user's learning style based on feedback from other users.

FIG. 25 is an embodiment of the method/process of the gamification function.

### DETAILED DESCRIPTION

One skilled in the art understands that many professionals in the education field recognize a plethora of learning styles, including but not limited to, learning styles associated with the auditory sensory, learning styles associated with the visual sensory, and learning styles associated with the tactile sensory. Also, one skilled in the art understands that learning style has been articulated in many ways including, but not limited to, learning method, learning process, learning process style, etc. This disclosure can be used on any or all of the recognized learning styles; however, this disclosure, for ease of understanding, is describing several widely recognized types of learning styles: auditory, visual, and tactile.

Educational theory supports that some people learn better from some stimuli than other stimuli. Students who learn from similar stimuli can potentially learn more efficiently by studying together. In contrast, students who learn from different stimuli may not learn as efficiently when they study together. By providing a mechanism to ascertain student's learning styles, students can more easily group themselves with other students who have similar learning style attributes. Students can, in one embodiment, self-group themselves. Moreover, students can choose professors who also enjoy their particular learning style.

Economic theory, such as Adam Smith's Invisible Hand of the Market, suggests that humans are motivated, by scarce resources, to channel their ambition toward socially desirable ends. In addition to this theory, “Gamification” is the use of game thinking and game mechanics in non-game contexts to engage users. By combining a scarce resource, such as a user score, with gamification, a system or method is created that can allow groups of people to channel their ambitions so that they can help each other study.

By providing a scoring mechanism in categories as well as an overall condensed score, students can see each other's score and they can see how useful other students are at group studying. Because a quantitative score will be available, the act of having a student score will guide students to seek help from the better students with better or higher scores. Moreover, the competitive nature of humans will incentivize students to try and obtain higher scores by helping other students study. Therefore, a scoring system allows students with higher scores to be rewarded and allow for students to strive for higher scores.

By adding a learning styles system and method to a gamification system and method, this system/method allows students, who self-study together, to find more efficient and better groups to study in. Also, by helping users self-select random study partners with more similar learning styles, there will likely be less friction and turmoil in the study room or study group. Self-study rooms often do not have a proctor or administrator and groups of students have to work together. By getting users with similar learning styles, it is less likely that there will be arguments or friction on how to study collectively. In addition, by adding a peer review where students will try to be better study partners, it creates a gamification where the entire educational environment is greatly improved. Therefore, this method/system of applying learning styles and gamification to a virtual classroom is a way at improving online education, especially online self-study education, because, if students are able to group themselves together with other users who have similar learning styles, students will likely learn quicker and easier together, improve the efficiency of education, and reduce the costs of education

Throughout this disclosure, reference is made to a teacher, professor, tutor, administrator, teaching assistant, teaching participant, etc. It is to be understood that these references can be used interchangeably. Furthermore, it is to be understood that a participant in a group may be a teaching participant and/or a learning participant.

Throughout this disclosure, reference is made to a student or learning participant. It is to be understood that these references can be used interchangeably.

Throughout this disclosure, it is to be understood that the use of the words “study” or “studying” can also mean the following: academic work, school work, group work, interactive work, consideration, debate, examination, exercise, inquiry, inspection, research, review, analyze, contemplation, memorize, etc.

Throughout this disclosure, reference is made to user or participant. Both terms, user and participant, are interchangeable terms and can be used to refer to a teacher, professor, tutor, administrator, student, teaching participant, or learning participant since they are all in the same virtual room, study room, study group, classroom, or conference.

Throughout this disclosure, reference is made to criterion, criterions, and criteria. It is to be understood that criteria and criterions are interchangeable forms of the plural of criterion.

Throughout this disclosure, reference is made to a scoring system. It is to be understood that scoring system is a method of quantifying students' or users' abilities. One skilled in the art will know that this scoring system could also be referred to as a grading system, answering system, or many other similar phrases.

Throughout this disclosure, reference is made to a study group, room, study room or conference, virtual classroom, virtual study room, conference room, conferences and conferencing. It is to be understood that these terms are all interchangeable. Also, it is to be understood that a study group, room, study room or conference, virtual study room, conference room, conferences and conferencing is any form of a conference communication, including but not limited to telecommunications, conference calls, webinars, electronic group meetings, and combinations of conference communication forms. Furthermore, it is to be understood that a study group, study room, or conference may be comprised of n participants, where n represents any number.

Reference is made to learning style quiz and it is to be understood that a learning style quiz could also be referred to as a learning style assessment, learning style questionnaire, learning style test, or learning style exam.

Reference in this specification to “Learning Style Category” means a category of learning style (e.g., visual learning style, auditory learning style, and/or tactile learning style) that relates to how a student or professor learns.

Reference in this specification to “Learning Style Composite” means the quantitative score describing a student's or professor's learning style. The Learning Style Composite identifies the Learning Style that a student or professor possesses.

Reference in this specification to “Learning Style Scores” means the scores of each type of Learning Style Category. In this disclosure, students and professors have several types of Learning Style Scores for each of the types of Learning Style Categories. One skilled in the art will understand that the process/method described in this disclosure could be used with various learning style modifications, including any learning style that their students could self-identify with, without departing from the broader spirit as set forth in this disclosure. Accordingly, the specific reference to these learning styles is to be regarded in an illustrative sense rather than in a restrictive sense.

Reference in this specification to “Learning Style Diagnostic Questions” means the diagnostic questions or statements that students self grade themselves on. Learning Style Diagnostic Questions help provide the Learning Style Scores and ultimately the Learning Style Composite and Learning Style Category of a student or professor. Learning Style Diagnostic Questions are questions or statements that relate to specific learning styles or learning style traits. Thus, Learning Style Diagnostic Questions are most easily discovered by asking a question that leads itself to quantifying how likely a user is at learning efficiently and easily with a type of learning style.

Reference in this specification to “Learning Style Questionnaire” means the questionnaire provided to students and professors that helps the system and method ascertain their Learning Style Category.

In the following description, for purposes of explanation, numerous specific details are set forth in order to provide a thorough understanding of the description. It will be apparent, however, to one skilled in the art that the invention can be practiced without these specific details. In other instances, structures and devices are shown in block diagram form in order to avoid obscuring the description.

Reference in this specification to “one embodiment” or “an embodiment” means that a particular feature, structure, or characteristic described in connection with the embodiment is included in at least one embodiment of the present disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In one embodiment of the present disclosure, in which a person studies with other students, they can choose to study with other students with similar learning styles. In another embodiment, the system or method can suggest or place students in groups with the most similar Learning Style Scores. In one embodiment, the more similar students' learning styles are to each other, the better their performance will be when the group study. Thus the system in accordance with the present disclosure involves a learning system (or learning method) that groups students who are likely to help each other study effectively and efficiently.

In another embodiment of the present disclosure, students can identify administrators, teachers, or tutors with a particular learning style. One skilled in the art will understand that allowing students to self-select teachers based on learning style is advantageous. Self-selection may also allow students to choose to interact with the learning style of their choice even if it does not follow the customary logic. The presently disclosed system/method does not dictate a preferred learning style and provides flexibility to the users. This augmentation improves online education because students are able to retain information quicker and more efficiently when learning is geared towards their learning style, thereby lowering the cost of education.

In an embodiment, users can score themselves on Learning Style Diagnostic Questions that represent different learning styles. Users are provided a series of questions or statements, called Learning Style Diagnostic Questions, and then each respective student answers each question, or confirms or denies each statement, about them. For example, a Learning Style Diagnostic Question such as “do you need to see a diagram, map or illustration before you can understand a concept or idea?” helps identify if the participant has a history of learning easily and efficiently as a visual learner. In this example, the Learning Style Diagnostic Question is the question and the quantifying score (i.e., Learning Style Score) helps establish what Learning Style Category the participant is in. In one embodiment, students score themselves on a group of Learning Style Diagnostic Questions and then this method/system calculates the user's Learning Style Composite, which illustrates what kind of Learning Style Category the student is in.

In an embodiment of the present disclosure, Learning Style Diagnostic Questions that could be used to gauge whether a user is a visual learner may include, but are not limited to, as follows: 1) I need diagrams, flowcharts, or illustrations to understand a subject, 2) I draw illustrations to help myself understand subject matter, 3) I have to read a book or text before I can understand a complex subject, 4) When I take an exam, I can often see the text, diagram or the teacher in my head, 5) If I had my choice, I would read the news rather than listen to the news, 6) Sometimes I don't get the meaning of jokes even when my friends are laughing. One skilled in the art understands that there are any multitudes of questions that can help ascertain the likelihood of a student being a visual learner and these are merely examples to help illustrate this disclosure and other questions could be used without departing from the broader spirit as set forth in this disclosure. Accordingly, the specific reference to these visual learning questions is to be regarded in an illustrative sense rather than in a restrictive sense.

In an embodiment of the present disclosure, Learning Style Diagnostic Questions that could be used to gauge whether a user is an auditory learner may include, but are not limited to, as follows: 1) I usually don't need to read a textbook because I can learn everything from being at the lecture, 2) I need someone to walk me through a diagram, map or illustration before I can understand it, 3) I only need to hear a couple of notes, cords, or words of a song to know what song is playing, 4) I prefer audio books or webcasts of lectures, 5) I would rather you just tell me directions than email me the directions, and 6) I easily tire of reading. One skilled in the art understands that there are any multitudes of questions that can help ascertain the likelihood of a student being a auditory learner and these are merely examples to help illustrate this disclosure and other questions could be used without departing from the broader spirit as set forth in this disclosure. Accordingly, the specific reference to these auditory learning questions is to be regarded in an illustrative sense rather than in a restrictive sense.

In an embodiment of the present disclosure, Learning Style Diagnostic Questions that could be used to gauge whether a user is an tactile learner may include, but are not limited to, as follows: 1) I prefer to rewrite my class notes, 2) I like to build posters or models, 3) I like to start projects before reading the instructions, 4) I rarely create an outline before I start writing an essay, 5) I excel when someone demonstrates or shows me how to do something, and 6) I take many study breaks. One skilled in the art understands that there are any multitudes of questions that can help ascertain the likelihood of a student being a tactile learner and these are merely examples to help illustrate this disclosure and other questions could be used without departing from the broader spirit as set forth in this disclosure. Accordingly, the specific reference to these tactile learning questions is to be regarded in an illustrative sense rather than in a restrictive sense.

In one embodiment of the present disclosure, a Learning Style Score is a method of quantifying students' or users' learning styles by grading the Learning Style Questions (e.g., the Learning Style Questionnaire).

In another embodiment, the answers to Learning Style Diagnostic Questions, or self-assessment questions, can be based on a numbering system or any system that allows dissemination of the Learning Style Diagnostic Questions' attributes (e.g., Learning Style Score). For example, a number scoring system can be a scale between 0 and n where n is a number and n is the highest score achievable for a Learning Style Diagnostic Question while 0 is a complete failure of the Learning Style Diagnostic Question. For example, students may rank the likeliness of their actions to a statement or question (e.g., Learning Style Diagnostic Question). In this case, if the Learning Style Diagnostic Question is “I learn best when I listen to a teacher's lecture,” then a self-assessment score of a 0 means the student rarely agrees with the statement, a self-assessment score of a 1 means the student sometimes agrees with the statement, or a self-assessment score of a 2 means the student always (or usually) agrees with the statement. In another embodiment, the scale could be between a negative n number and a positive n number, such as −5 and +5. In another embodiment, the scale could be between a negative n number and zero, such as −5 and 0. One skilled in the art will understand this is an example and a specific number need not correspond to these exact meanings or phrases. One skilled in the art would understand that there are many ways to articulate a quantitative number and no two administrators, teachers, students, professors, or one skilled in the art will articulate it the same exact way. Moreover, one skilled in the art will understand that the scoring system described in this paragraph can be reversed where the best score is the lowest score and the highest score is the worst score. In a system design constructed in this latter manner, the best score is the lowest score instead of being the highest score.

In another embodiment, the answers to Learning Style Diagnostic Questions, or self-assessment questions, can be based on a binary question system or any system that allows dissemination of the Learning Style Diagnostic Questions' attributes (i.e., Learning Style Score). For example, a binary scoring system can be a question that asks a student if they agree with a statement and the student can check a box for yes or no.

In one embodiment, students or users may not be given a choice and may be required to take a Learning Styles Questionnaire. A Learning Style Questionnaire (which is referenced in process operation 520) may contain criteria where some of the criteria represent a visual learning style, some of the criteria represent an auditory learning style, and some questions represent a tactile learning style. The score in each of the three (3) learning style categories can be calculated to indicate what type of style learner the user is. One skilled in the art understands that there are any multitudes of questions that can help ascertain the learning style of a student and having 6 questions for each category should not be construed as a limiting number; rather it is being used as an example to help illustrate this disclosure.

A person skilled in the art will understand that the scores of Learning Style Diagnostic Questions can be averaged together for an overall score (i.e., Learning Style Composite), subgroups of Learning Style Diagnostic Questions can also be averaged together.

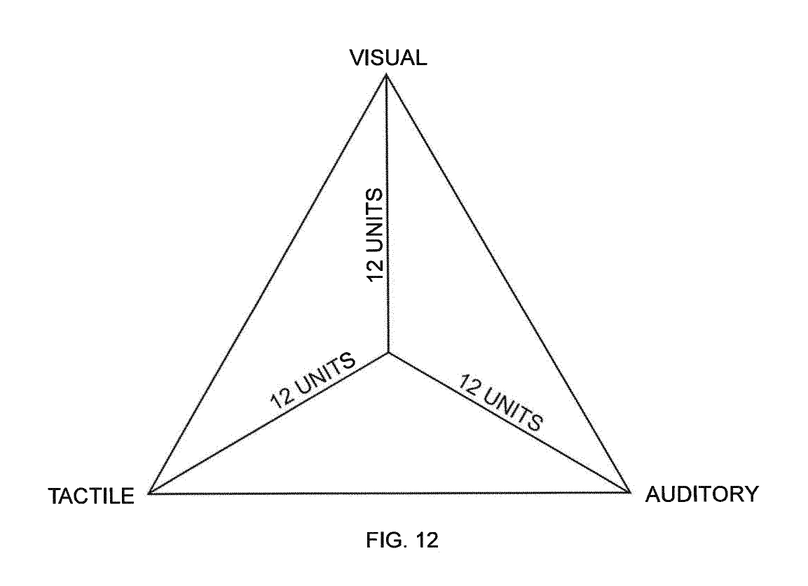

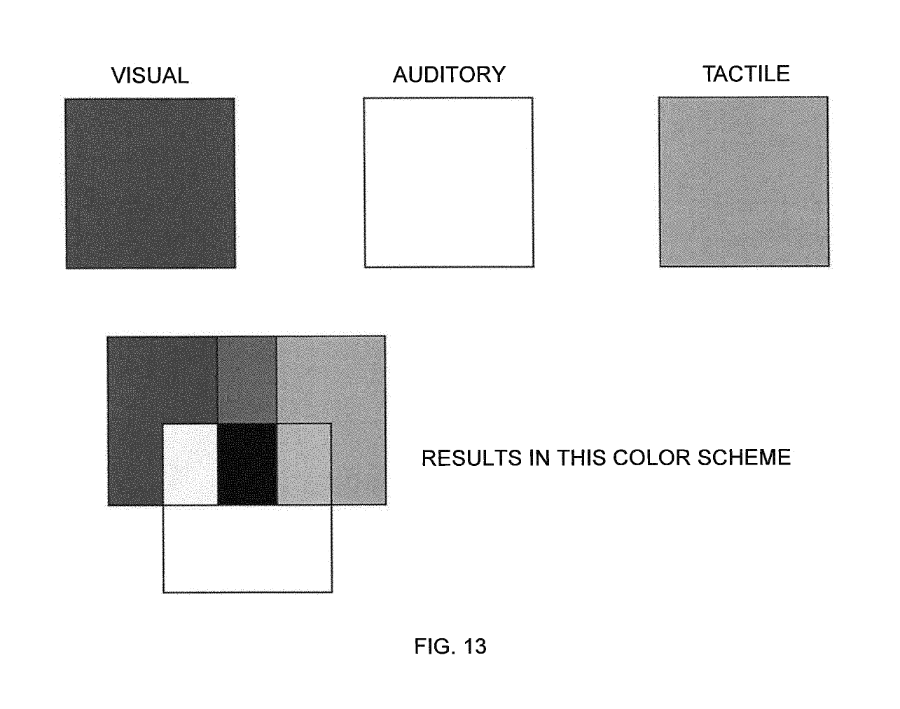

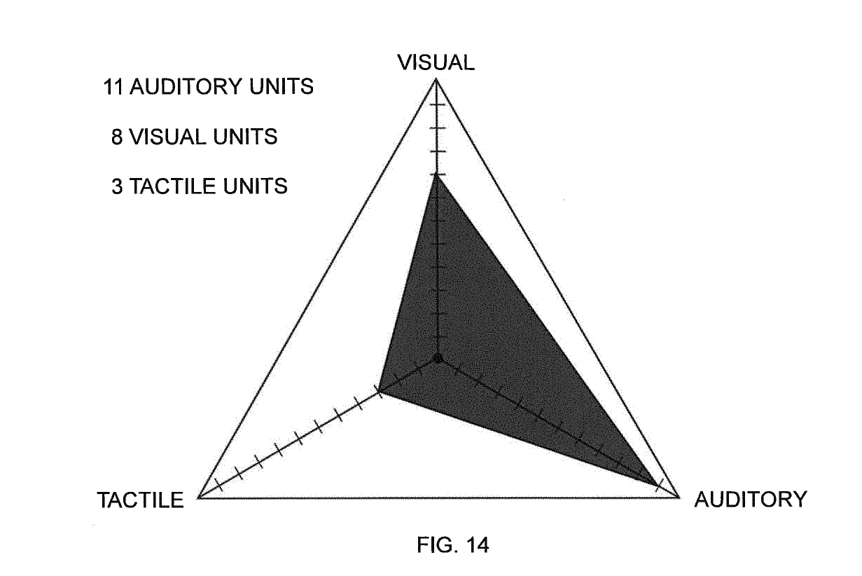

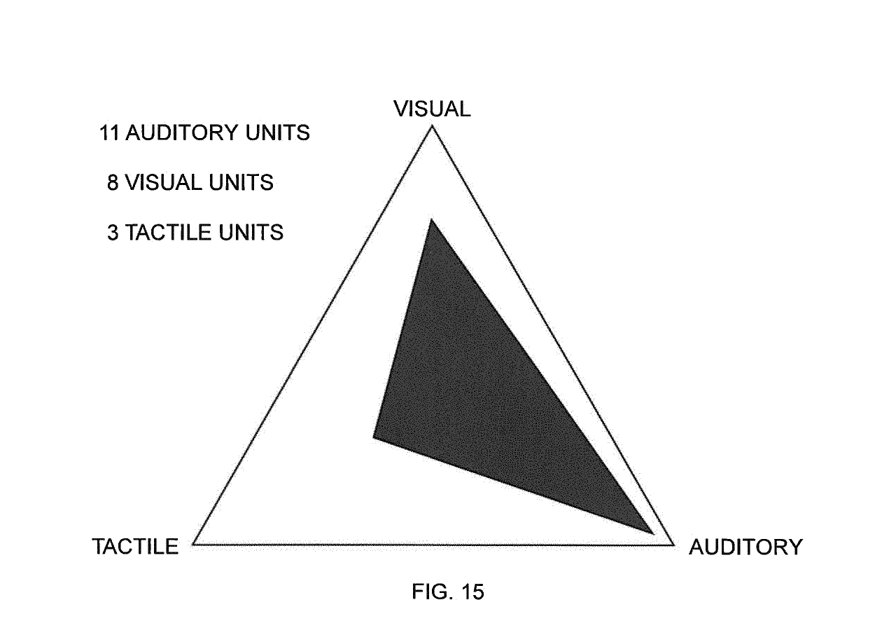

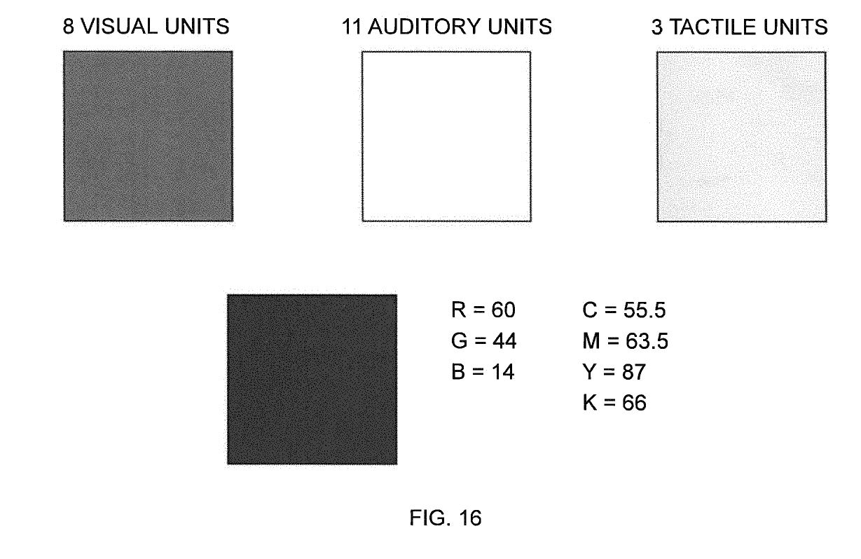

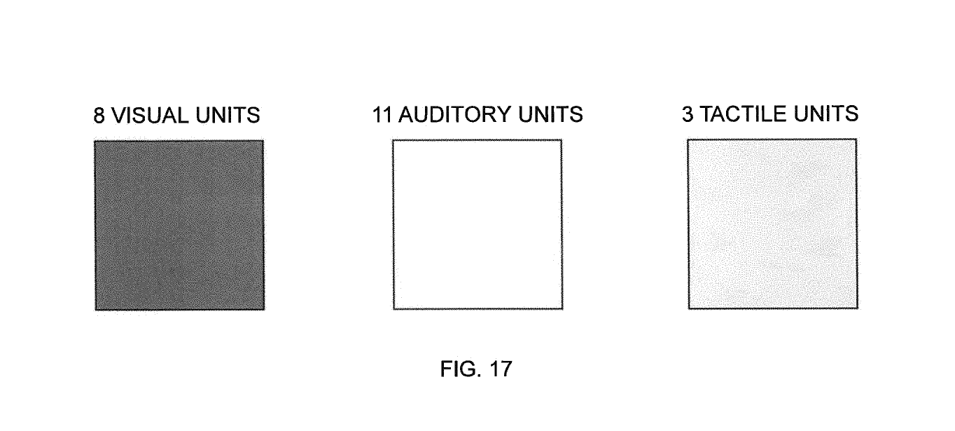

In an embodiment of the present disclosure, the scores of all of the Learning Style Diagnostic Questions for each Learning Style Category (e.g., visual, auditory, and tactile) are added together (i.e., Learning style Composite) and displayed visually using FIGS. 12, 13, 14, 15, 16, and 17.

In an embodiment, Learning Style Scores can be disseminated to other students per individual Learning Style Diagnostic Question, groups or subgroups of Learning Style Diagnostic Questions, or as an average of the Learning Style Diagnostic Questions. For instance, a study room could list each participant's name with Learning Style Scores of the each participant's Learning Style Categories, e.g., auditory, visual, and tactile. Alternatively, an administrator may set how scores are disseminated or displayed for their class, school, university, or program.

In an embodiment, Learning Style Scores can be disseminated to other students per individual Learning Style Diagnostic Question, groups or subgroups of Learning Style Diagnostic Questions, or as an average of the Learning Style Diagnostic Questions. For instance, a study room could list each participant's name with the Learning Style Composite. Alternatively, an administrator may set how Learning Style Composites are disseminated or displayed for their class, cohort, school, university, or program.

In an embodiment, Learning Style Scores can be disseminated to other students per individual Learning Style Diagnostic Question, groups or subgroups of Learning Style Diagnostic Questions, or as an average of the Learning Style Diagnostic Questions. For instance, a study room could list each participant's name with the Learning Style Category. Alternatively, an administrator may set how Learning Style Composites are disseminated or displayed for their class, school, university, or program.

In one embodiment of the learning system/method in accordance with the present disclosure, each student in the group study room can see students' Learning Style Scores. In another embodiment, the Learning Style Scores of students in the group study room can be displayed as one (1) overall composite score for the group study room. In another embodiment, each student in the group study room can see students' Learning Style Composite. In another embodiment, the Learning Style Composites of students in the group study room can be displayed as one (1) overall composite score for the group study room. In another embodiment, each student in the group study room can see students' Learning Style Category. In another embodiment, the Learning Style Categories of students in the group study room can be displayed as one (1) overall composite score for the group study room. In an embodiment, each participant, student, or user in the study room has access to other participant's names or user's names so they can identify and/or recognize each user. Moreover, each student can see each other's Learning Style Category.

In one embodiment of the present disclosure, in which a person studies with other students, they are graded or scored on each other's interactions during a study session. The better their peers feel they performed, the better and potentially higher their score or grade. Thus, the system in accordance with the present disclosure involves a gamification scoring system (or grading system) that can incentivize students to help each other study.

Students can be scored on any criterion. Some examples are, but not limited to, helpfulness, reliability, congeniality, diligence, cordiality, affability, studiousness, maturity, professionalism, and knowledge level. In one embodiment of this gamification system/method of the present disclosure, students can provide scores of students who participated in the group study room after they each leave the study room. Students can score each user after each user leaves the study room. At that same time, the user who leaves the room also can score the student and users who remain in the study room. In other embodiments, an outside observer such as an administrator, teacher or facilitator can do the observing and the grading. The administrator has the option of also allowing the students to grade other students.

In the following description, for purposes of explanation, numerous specific details are set forth in order to provide a thorough understanding of the description. Students can be scored on “Criteria Categories” (or singular as “Criterion Category”), which are a multitude of different criterion including, but not limited to, their helpfulness towards other students, reliability, congeniality, diligence, cordiality, affability, studiousness, maturity, and professionalism as well as their knowledge level. One skilled in the art understands that there are any multitudes of Criteria Categories that can help ascertain the likelihood of a student being a productive member of a self-study group. These categories are merely examples to help illustrate this disclosure and other categories could be used without departing from the broader spirit as set forth in this disclosure. Accordingly, the specific reference to these Criteria Categories is to be regarded in an illustrative sense rather than in a restrictive sense.

Reference throughout this disclosure to “Criterion Category Scores”, “Criterion Category Score”, “Criteria Category Scores”, or “Criteria Category Score” is references to the quantitative number or aggregate score for a particular Criterion Category or Criterion Categories.

Students can score other students on each criterion using a numbering system or any system that allows dissemination of the criteria attributes. The outcome of this scoring process is the Criterion Category Score. For example, a number scoring system can be a scale between 0 and n where n is a number and n is the highest score achievable for the criterion while 0 is a complete failure of the criterion. For example, students may rank other students' professionalism, which is a type of criterion, on a scale of 0 to 5 where 5 is professional, 4 is mostly professional, 3 is adequately professional, 2 is professionalism needs improving, 1 is lack of professionalism, and 0 is no professionalism. In another embodiment, the scale could be between a negative n number and a positive n number, such as −5 and +5. In an alternative embodiment, the scale could be between a negative number n and zero, such as −5 and 0. This is an example and a specific number need not correspond to these exact meanings or phrases. One skilled in the art would understand that there are many ways to articulate a quantitative number and no two administrators, teachers, professors, or one skilled in the art will articulate it the same way. Moreover, one skilled in the art will understand that the scoring system described in this paragraph can be reversed where the best score is the lowest score and the highest score is the worst score. In a system design constructed in this manner, the best score is the lowest score instead of being the highest score.

In one embodiment of scoring for Criterion Categories (i.e., Criterion Category Scores), the possibility that a student did not participate, i.e., was quiet and not speaking during the group meeting in the room, is taken into account by providing a grade, score, or answer of “did not speak”, “not applicable”, or “unknown.”

In one embodiment of scoring, the possibility that a student will not remember how another student performed in the group meeting in the room is taken into account by allowing a grade, score, or answer of “did not speak”, “not applicable”, “not enough experience to answer”, or “unknown.”

In one embodiment, students or users may not be given a choice and may be required to answer each criterion.

Criterion Category Scores can be disseminated to other students per individual criterion, groups or subgroups of criterion, or as an average of the criteria. For instance, a study room could list each participant's name with scores of the each participant's Criteria Categories, e.g., helpfulness, maturity, professionalism and knowledge level. Furthermore, the score under each respective criterion, such as “Knowledge Level,” could be listed as a lifetime score, score per study room instance, average score per hour, average score per grading, average score per grading instance, etc. The choice on how students view the scores (e.g., lifetime score, score per study room, average score per hour, average score per grading, average score per grading instance etc.) is up to each individual student or user. Alternatively, an administrator may set how scores are disseminated or displayed for their class, school, university, or program.

A person skilled in the art will understand that while all types of criterion can be averaged together for an overall score, subgroups of criterion can also be averaged together. For example, maturity and professionalism are two similar criteria and an average of these two criteria could be used and disseminated to students as a combined criterion. In this embodiment, a student could have a maturity-professionalism Criterion Category Score of 8.3 out of 10.

It is to be understood that “perfect information” is an economics and game theory term that signifies that each participant has perfect information if each participant, when making any decision, is perfectly informed of all the events that have previously occurred, i.e., complete, up to date information. In an embodiment, the Learning Style Categories and Criterion Categories are continually updated based on prior events (e.g., scoring by other participants) so participants can make the best choices on whom to study with.

Each participant, student, or user in the study room has access to other participant's or user's names so they can identify and/or recognize each user. The names of the students, participants or users do not necessarily need to be legal or factual names and they can be a username, a type of alias, a unique identifying number, a unique set of character(s), biometric data, or a unique string of character(s) and/or number(s).

In an embodiment, the Learning Style Category can be depicted using FIGS. 12, 13, 14, 15, 16, and 17. In another embodiment, the Learning Style Composite can be depicted using FIGS. 12, 13, 14, 15, 16, and 17. In yet another embodiment, the Learning Style Scores can be depicted using FIGS. 12, 13, 14, 15, 16, and 17.

In an embodiment, a user's Learning Style Category, Learning Style Composite, and/or Learning Style Score can be refined or improved by getting feedback from other users who interacted with the user in the virtual study rooms. Thus, a user's learning style is being better refined after each study group session.

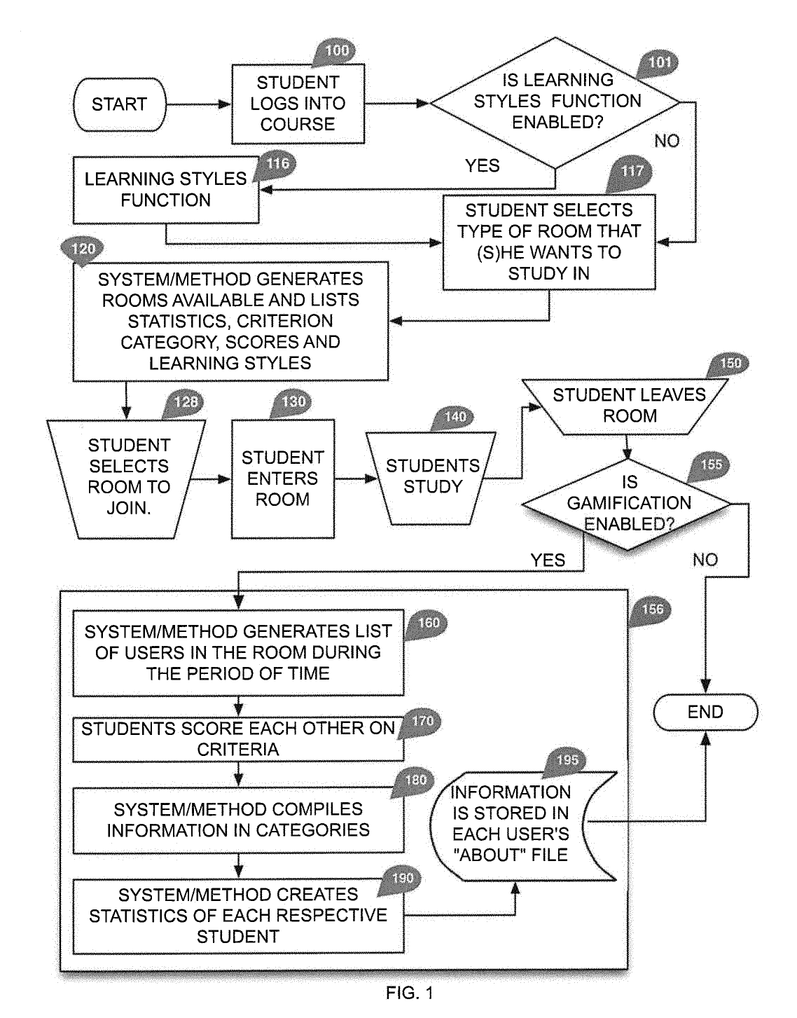

An exemplary embodiment of a process/method of generating a virtual study room gamification system with learning styles is shown in the flow diagram of FIG. 1. The process begins in operation 100 in which a student or user logs into the online course, on line conference, online classroom, system and/or method. Process control then transfers to query operation 101. In query operation 101, the system/method queries whether the Learning Styles Function is enabled. While the most popular embodiment will allow the administrator or professor to have the ability to enable or disable this function, other embodiments may allow any user (or other users in addition to a professor or administrator) to have the ability of enabling or disabling this function. If the answer is yes to query 101, then the flow of process operations moves to process operation 116. If the answer is no to query 101, then the flow of this method/system moves to process operation 117.

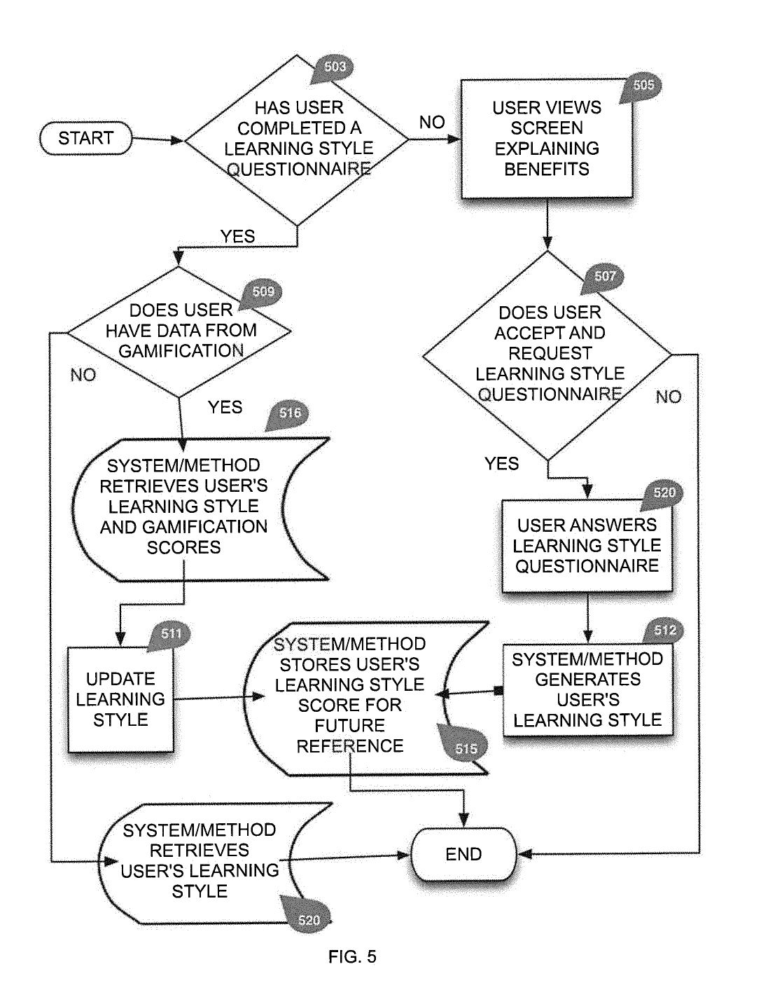

In process operation 116, the system/method activates the Learning Style Function. An embodiment of this function is found in FIG. 5 and is also discussed in detail below. Process control then transfers to process operation 117. In process operation 117, a student or user selects the type of room they will or wish to study in. This study room may be described by any criteria, including but not limited to, a chapter of a book, study unit of an online course, a specific class, school program, cohort, business segment, company division, company team, or any subject matter. This study room could be open to the public or a private room that requires invitation or a password. Moreover, this room could be a pre-set room created by a user, teacher or administrator. Process control then transfers to process operation 120.

In process operation 120 a list of rooms fitting the parameters the student chose in process 117 is generated and displayed to the student. In this generated list, the scores of Criterion Categories (e.g., Criterion Category Scores), scores of learning styles (e.g., Learning Style Scores), and statistics of the users inside these rooms are made available to the student. Examples include total score for both helpfulness and knowledge as well as average score per hour for helpfulness and knowledge. This could be listed for each user in the study room or in an overall condensed number taking into account each user in the room. Examples for learning styles are indications of students' dominant learning style and/or a breakdown of how each student is with respect to a specific learning style's scale. Examples of statistics include average time studying, length of time of progression in course, and other general relevant statistics. In one embodiment, the Learning Style Scores and/or the Learning Style Composite could be displayed. In another embodiment, the Criteria Category Scores or the score of each Criterion Category could be displayed. In another embodiment, both the previous two embodiments could be combined.

In one embodiment of process operation 120, the student can see the Learning Styles Scores for each user inside each listed study room. The student can then choose the room that bests suits him or her given the scores and learning styles of students within each study room. A user may wish to join a room that has users holding best (or highest) scores or students with similar learning styles, Learning Style Categories, Learning Style Scores, Criterion Category Scores, and/or Learning Style Composites. However, a user may also join a room based on the number of users in the room. For example, a user may wish to join a room with less than best scores if it has greater than x number of users or less than x number of users; where x is variable equal to any number, but equals a student's or user's arbitrary preference. Moreover, a student or user may prefer to join a room with exactly x number of students. One skilled in the art will appreciate that this embodiment accommodates students who prefer smaller or larger rooms.

In another embodiment of process operation 120, the student can see an aggregated score (of either the Learning Style or Criterion Categories, or both) for the study room. This aggregated score can be an average of the scores of all of the scorable or gradable criteria for each student or a one-score average that takes into account all of the criteria of all of the students currently within the study room. In one embodiment, this one-score average may be an average of a sub-group of criteria. In addition, process operation 120 allows the student to also see the Learning Style Category or Categories of each student. In another embodiment, the entire study room's learning style can be displayed as a one-score average (e.g., Learning Style Composite). Once process operation 120 is complete, i.e. the scores and list of study rooms are displayed to the student, control transfers to operation 128.

In process operation 128, a student selects the study room he or she wants to join. The student can choose the room based on user-specific information, user-specific preferences, and/or perfect information (as a defined economics and/or game theory term) of the system/method rather than the system/method choosing or dictating the choice for the student. Control then transfers to operation 130.

In process 130, the student enters into the study room with other students or if no user is present in the virtual study room, a study room is created and this student is the first participant. Other students/users may join the student in the study room so created. In an embodiment, a virtual classroom or virtual conference room is created and the student enters as discussed in Multidimensional Virtual Learning System and Method (Non-Provisional patent application Number: U.S. patent application Ser. No. 14/460,575, filed Aug. 15, 2014). Control then transfers to process operation 140.

In process 140, students and/or users study together and they help each other answer questions and/or learn the material. The student remains in the room for a period of time. Control then transfers to process operation 150.

In process operation 150, the student leaves the virtual study room. However, the reason the student leaves the room could be any reason including, but not limited to, completed necessary studying, tired of studying for the time being, a poor internet connection, other I.T. issue, or due to expulsion by administrator, teacher, and/or students that could cause the student to leave the room. Control then transfers to process operation 155.

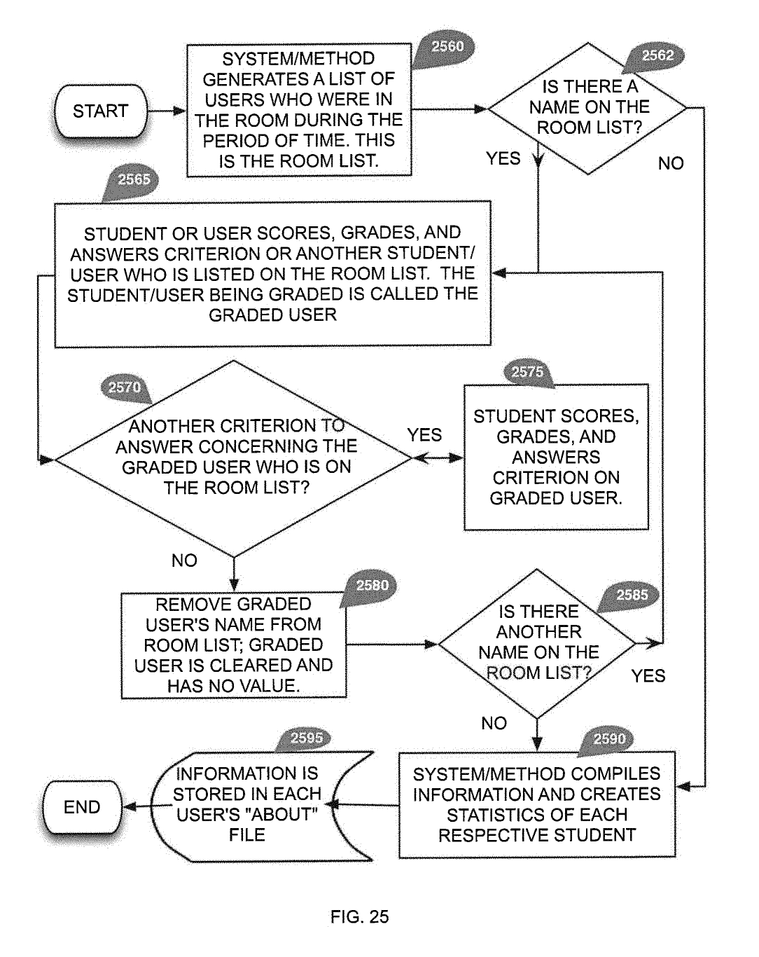

In query operation 155, the system/method queries whether the Gamification Peer Review Function is enabled. In one embodiment, the Gamification Peer Review Function is represented in FIG. 1 as block 156. (In another embodiment, the Gamification Peer Review Function is represented in FIG. 25). If the answer is yes to query 155, then the flow of process operations moves to process operation 160, which is within block of operations 156. If the answer is no to query 155, then the method/system ends.

In process operation 160, the system/method generates and displays a list of users who were in the virtual room during the period of time that the student studied in the virtual classroom. Control then transfers to process operation 170.

In process 170, using the list generated in process 160, the student scores, grades, and/or answers criterion involving each user who studied with the student in the room. This is also new and novel because a plethora of students or users are providing feedback rather than one administrator or user.

In one embodiment of process 170, each student that was in the study room is listed one-by-one followed by a list of the criterion with instructions on how to grade, score, or answer the criterion. Therefore, the student answers, grades, or scores the criterion for each student on the generated list one at a time. After the student is finished answering, grading, or scoring one student, then a subsequent student on the list is listed for the student to score. The student scores, grades, or answers criterion on this next student. The process continues until the student scores, grades, or answers the criterion for every student who was in the study room during the period of time. In another embodiment, the student can see each student's learning style, Criterion Category Score(s), Learning Style Composite, Learning Style Scores, and/or Learning Style Category. In an embodiment, criterion may query answers concerning Learning Style Categories (e.g., learning styles) and specific user's Learning Style Categories. In another embodiment, criterion may query answers concerning any type of criterion and Learning Styles.

In one embodiment of process operation 170, criterions are listed on a single page. The student answers criteria before proceeding to score, grade or answer criteria of next student.

In an alternative embodiment of process operation 170, a criterion is listed and a list of student names is associated with this criterion. The student scores, grades, or answers this criterion for students before proceeding to answer the next criterion. In another embodiment, students can grade other students on how well they performed per their learning style. This embodiment allows the system in operation 190 to refine each student's learning style. In another embodiment, process operation 170 allows the system/method to refine each Criteria Category in operation 190. At the end of process operation 170, control transfers to process operation 180.

In process operation 180, the system/method compiles the student's scores, grades and/or answers concerning users in the room. The method/system sums the scores of each grading criterion and after compiling the scores, the system/method creates scoring statistics for each respective user who was in the room (process operation 190). Control then transfers to operation 195. In process operation 195, the system/method stores the information concerning each student's or user's scores for future reference, use, or display.

In another embodiment, process operation 190 requires the system/method to compile the scoring, grading, or answer information of each administrator, professor, student, and user and creates statistics of each student who was graded, scored or answered. In one embodiment, the scores of criterions are improved or augmented by additional user information. In another embodiment, the scoring, grading, or answer information may update, refine or improve Criteria Categories, a Learning Style Categories (e.g., learning styles), and/or Learning Style Composites.

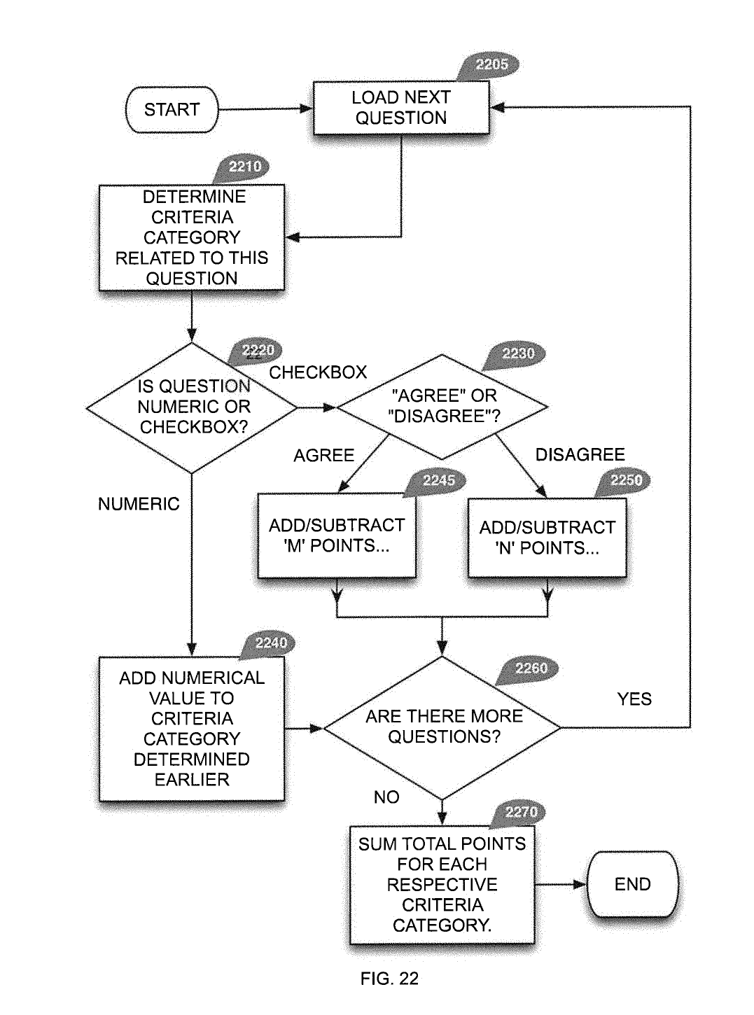

In one embodiment, process operations 180 and 190 are combined into one process, system, and/or method. An exemplary embodiment of this concept is shown in FIGS. 22, 23, and 24 and discussed below. FIGS. 22, 23, and 24 can be combined, but they do not need to be combined to facilitate process operations 180 and 190. Moreover, they can be used individually or in any combination.

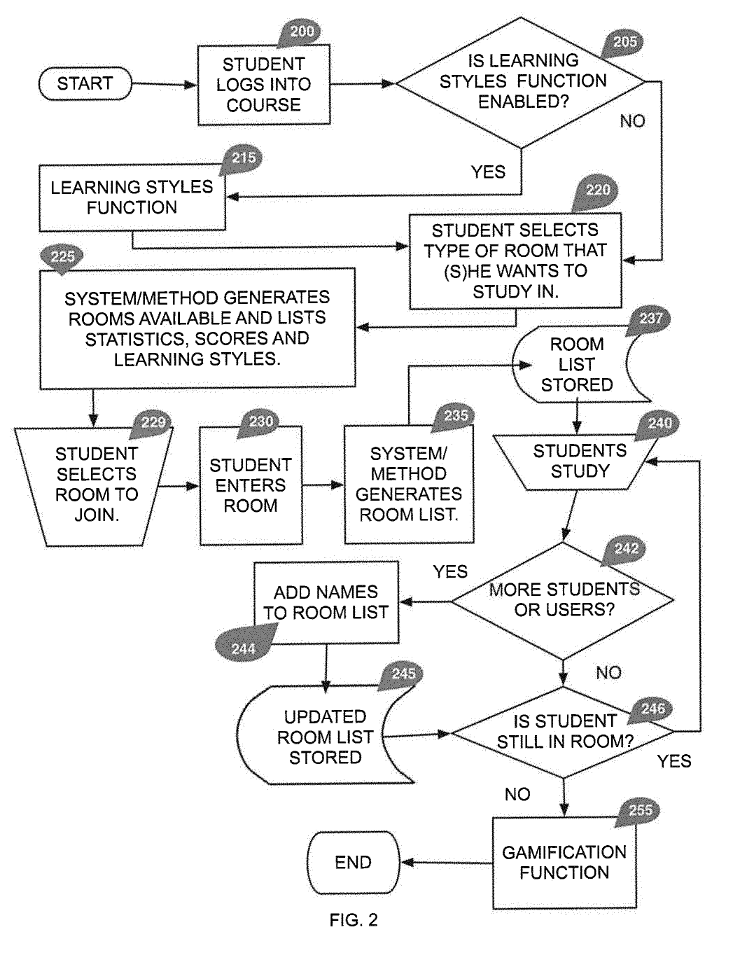

An exemplary embodiment of a process/method of generating a virtual study room gamification system with learning styles is shown in the flow diagram of FIG. 2. The process begins in operation 200 in which a student or user logs into the online course, on line conference, online classroom, system and/or method. Process control then transfers to query operation 205.

In query operation 205, the system/method queries whether the Learning Styles Function is enabled. While the most popular embodiment will allow the administrator or professor to have the ability to enable or disable this function, other embodiments may allow any user (or other users in addition to a professor or administrator) to have the ability of enabling or disabling this function. If the answer is yes to query 205, then the flow of process operations moves to process operation 215. If the answer is no to query 205, then the flow of this method/system moves to process operation 220. In process operation 215, the system/method activates the Learning Style Function. An embodiment of this function is found in FIG. 5 and is also discussed in detail below. Process control then transfers to process operation 220.

In process operation 220, a student or user selects the type of room they will or wish to study in. This study room may be described by any criteria, including but not limited to, a chapter of a book, study unit of an online course, a specific class, a school program, cohort, business segment, company division, company team, or any subject matter. This study room could be open to the public or a private room that requires invitation or a password. Moreover, this room could be a pre-set room created by a teacher or administrator. Process control then transfers to process operation 225.

In process operation 225, a list of rooms fitting the parameters the student chose is generated. In this generated list, the scores of Criterion Categories (e.g., Criterion Category Scores), scores of learning styles (e.g., Learning Style Scores), and statistics of the users inside these rooms are made available to the student. Examples include total score for both affability and diligence as well as average score per hour for affability and diligence. This could be listed for each user in the study room or in an overall condensed number taking into account each user in the room. Examples for learning styles are indications of students' dominant learning style and/or a breakdown of how each student is with respect to a specific learning style's scale. Examples of statistics include average time studying, length of time of progression in course, and other general relevant statistics. In one embodiment, the Learning Style Scores and/or the Learning Style Composite could be displayed. In another embodiment, the Criteria Category Scores or the score of each Criterion Category could be displayed. In another embodiment, both the previous two embodiments could be combined.

In one embodiment of process operation 225, the student can see the Learning Style Score for each user inside each listed study room. The student can then choose the room that bests suits him or her given the scores and learning styles of students within each study room. One skilled in the art will understand that a user may wish to join a room that has users holding best (or highest) scores or students with similar learning styles, Learning Style Categories, Learning Style Scores, and/or Learning Style Composites. However, one skilled in the art will also understand that a user may join a room based on the number of users in the room. For example, a user may wish to join a room with less than best scores if it has greater than a number of users or less than a number of users.

In another embodiment of process operation 225, the student can see Criterion Category Scores including, but not limited to, an aggregated Criterion Category Score or aggregated Criteria Category Scores. This aggregated score can be an average of the scores of all of the scorable or gradable criteria for each student or a one-score average that takes into account the criteria of the students currently within the study room. One skilled in the art will understand that this one-score average may be an average of a sub-group of criteria. In one embodiment, this one-score average may be an average of a sub-group of criteria. In addition, process operation 225 allows the student to also see the learning styles of each student. In another embodiment, the entire study room's Learning Style Category or Learning Style Composite can be displayed as a one-score average.

In process operation 229, a student selects the study room he or she wants to join. The student can choose the room based on user-specific information, user-specific preferences, and/or perfect information (as a defined economics and/or game theory term) of the system/method rather than the system/method choosing dictating the choice for the student. Control then transfers to operation 230.

In process operation 230, the student enters into the study room with other students or, if no user is present in the virtual study room, a study room is created and this student is the first participant. In an embodiment, a virtual classroom or virtual conference room is created and the student enters as discussed in Multidimensional Virtual Learning System and Method (Non-Provisional patent application Number: U.S. patent application Ser. No. 14/460,575, filed Aug. 15, 2014). Control then transfers to process operation 235.

In process operation 235, a list of users currently in the room initially is generated. This list is referred to as “Room List.” One skilled in the art will understand that the Room List can be referred to as any number of similar, but different names. Control then transfers to operation 237. In process operation 237, this “Room List” is stored for future use. This future use may be a use where the list is edited and/or used in another process. Control then transfers to process operation 240. In process 240, the student studies together with other students and/or users and they help each other answer questions and/or learn the material. The student remains in the room for a period of time. Control then transfers to query operation 242.

In query operation 242, the system/method queries whether more students or users have joined the study room. If the answer is yes to query 242, then the flow of process operations moves to process operation 244. If the answer is no to query 242, then the flow of this method/system moves to query operation 246. In process operation 244, new names of users are added to the “Room List.” After process operation 244 is completed, the flow of process goes to process operation 245.

In process operation 245, this updated “Room List,” which has additional and new names, is stored for future use. This future use may be a use where the list is edited and/or used in another process operation. Control then transfers to query operation 246.

In query operation 246, the system/method queries whether the student is still in the study room. If the answer is yes to query operation 246, then the flow of process, i.e., control, transfers or moves to process operation 240. If the answer is no to query 246, then the student has left the study room. This is likely due to the choice of the student. However, the reason the student leaves the room could be any reason including, but not limited to, completed necessary studying, tired of studying for the time being, a poor internet connection, other I.T. issue, or due to expulsion by administrator or teacher could cause the student to leave the virtual room. Control then transfers to process operation 255.

In process operation 255, the Gamification Peer Review Function is activated or run. In one embodiment, the Gamification Peer Review Function is represented in FIG. 25 and discussed below. After the Gamification Peer Review Function is run, the method/system ends. In another embodiment, the administrator or users are allowed to enable or disable the Gamification Review Function and, in this embodiment, if the Gamification Peer Review Function is disabled, then the system/method would end after the student leaves the room. In another embodiment, process operation 255 utilizes the Gamification Peer Review Function as represented in block 156 of FIG. 1 as discussed above.

An exemplary embodiment of a process/method of the Gamification Peer Review Function is shown in the flow diagram of FIG. 25. The process begins in operation 2560 in which the system/method generates a list of users who were in the room during the period of time. This list is the Room List. Control then transfers to query operation 2562. In query 2562, the system/method queries whether there is a name on the Room List. If the answer is yes to query 2562, then control, i.e. the flow of process, moves to process operation 2565. If the answer is no to query 2562, then control, i.e. the flow of this method/system moves to process operation 2590.

In process operation 2565, the student or user scores, grades, and/or answers how another student or user, who is on the Room List, performed on a criterion. The student or user being scored, graded or answered is referred to as the “Graded User.” A person skilled in the art understands there are many different terms that are synonyms and can also be used to describe a Graded User. In another embodiment, the student can see each student on the Room List's learning style, Criterion Category Score(s), Learning Style Composite, Learning Style Scores, and/or Learning Style Category. In another embodiment, students can grade other students on how well they performed per their learning style. This embodiment allows the system in operation 2590 to refine each student's learning style.

In another embodiment of operation 2565, a criterion is listed and a list of student names is associated with this criterion. The student scores, grades, or answers this criterion for all students. In another embodiment, students can grade other students on how well they performed per their Learning Style Category and/or Learning Style Composite. This embodiment allows the system in process operation 2590 to refine, augment, or improve each student's learning style and/or Criteria Category. Control then transfers to query operation 2570.

In query operation 2570, the system/method queries whether there is another criterion to answer concerning the Graded User, who is listed on the Room List. If the answer is yes to query 2570, then the flow of process moves to process operation 2575. If the answer is no to query 2570, then the flow of this method/system moves to process operation 2580.

In process operation 2575, the student or user scores, grades, and/or answers how the Graded User, who is on the Room List, performed on a criterion. In one embodiment, the student or user being scored, graded or answered is referred to as the “Graded User.” A person skilled in the art understands there are many different terms that are synonyms and can also be used to describe a Graded User. In another embodiment of operation 2575, a criterion is listed and a list of student names is associated with this criterion. The student scores, grades, or answers this criterion for the students. In another embodiment, students can grade other students on how well they performed per their Learning Style Category and/or Learning Style Composite. This embodiment allows the system in process operation 2590 to refine, augment, or improve each student's learning style and/or Criteria Category. After process operation 2575 is complete, the system/method returns to query operation 2570.

In process operation 2580, the Graded User's name is removed from the Room List. The Graded User's name is not stored. After this process is complete, the system/method moves to query operation 2585. In query operation 2585, the system/method queries whether there is another student on the Room List. If the answer is yes to query operation 2585, then the flow of process moves to process operation 2565. If the answer is no to query 2585, then the flow of this method/system moves to process operation 2590.

In process operation 2590, the system/method compiles the scoring, grading, or answer information of each student and creates statistics of each student who was graded, scored or answered. In one embodiment, the scores of criterions are improved or augmented by additional user information. In another embodiment, the scoring, grading, or answer information may update, refine or improve Criteria Categories, Learning Style Composite and/or a Learning Style Category. An exemplary embodiment of this concept is shown in FIGS. 22, 23, and 24 and discussed below. FIGS. 22, 23, and 24 can be combined, but they do not need to be combined to facilitate process operation 2590. Moreover, they can be used individually or in any combination. Control then transfers to process operation 2595. In process operation 2595, the system/method saves the information concerning each student's or user's scores for future reference, use, or display.

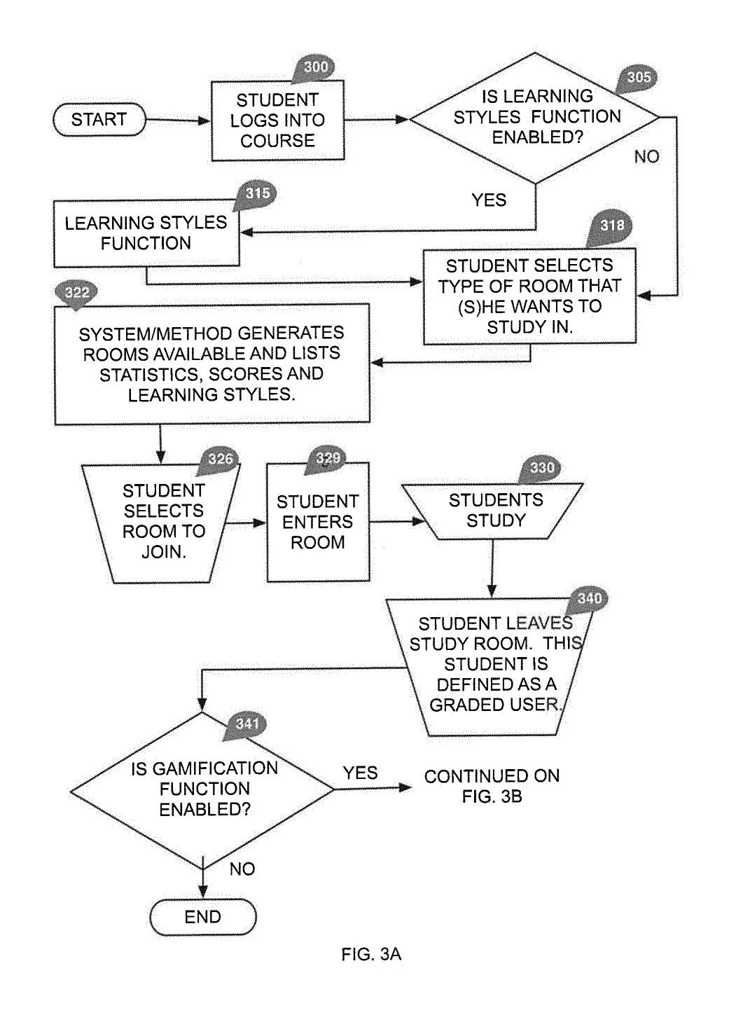

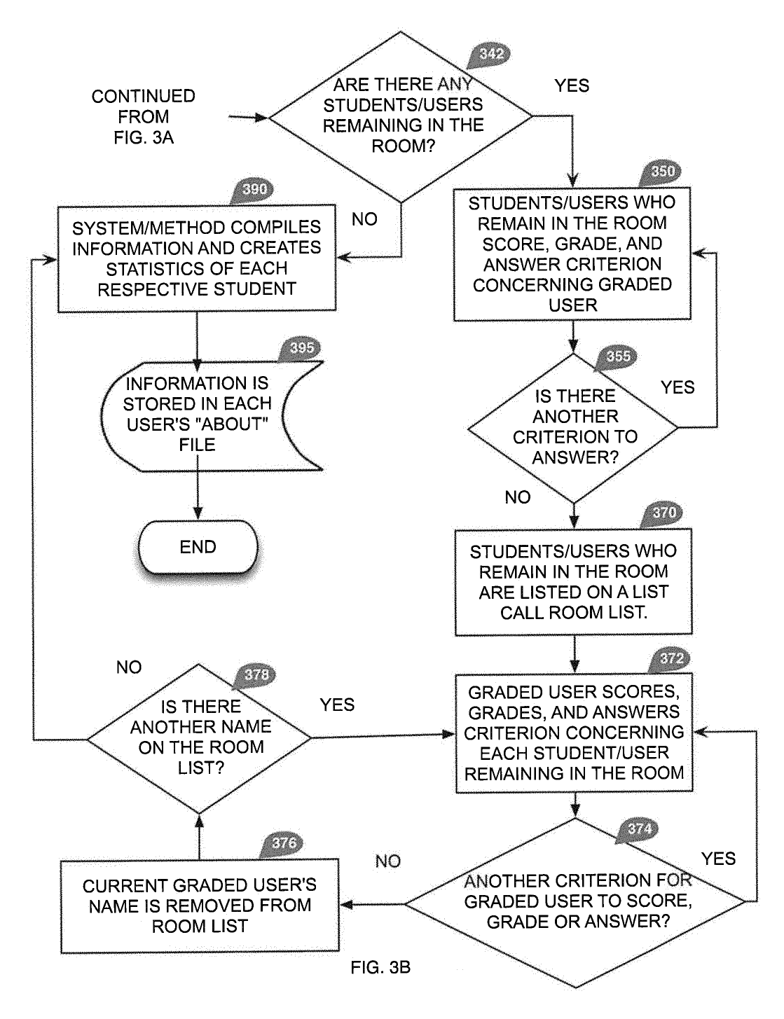

Another exemplary embodiment of a process/method of generating a virtual study room gamification system with learning styles is shown in the flow diagram of FIG. 3. The process begins in operation 300 in which a student or user logs into the online course, online conference, online classroom, system and/or method. Process control then transfers to query operation 305. In query operation 305, the system/method queries whether the Learning Styles Function is enabled. While an embodiment will allow the administrator or professor to have the ability to enable or disable this function, other embodiments may allow any user (or other users in addition to a professor or administrator) to have the ability of enabling or disabling this function. If the answer is yes to query 305, then the flow of process operations moves to process operation 315. If the answer is no to query 305, then the flow of this method/system moves to process operation 318.

In process operation 315, the system/method activates the Learning Style Function. An embodiment of this function is found in FIG. 5 and is also discussed in detail below. Process control then transfers to process operation 318. In process operation 318, a student or user selects the type of room they will or wish to study in. This study room may be described by any criteria, including but not limited to, a chapter of a book, school program, cohort, study unit of an online course, a specific class, or any subject matter. This study room could be open to the public or a private room that requires invitation or a password. Moreover, this room could be a pre-set room created by a teacher or administrator. Control then transfers to operation 322.

In process operation 322 a list of rooms fitting the parameters the student chose is generated and displayed. In this generated list, the scores of Criterion Categories (e.g., Criterion Category Scores), scores of learning styles (e.g., Learning Style Scores), and statistics of the users inside these rooms are made available to the student. Examples include total score for both maturity and professionalism as well as average score per hour for maturity and professionalism. This could be listed for each user in the study room or in an overall condensed number taking into account each user in the room. Examples for Learning Styles are indications of students' dominant learning style and/or a breakdown of how each student is with respect to a specific learning style's scale. Examples of statistics include average time studying, length of time of progression in course, and other general relevant statistics. In one embodiment, the Learning Style Scores and/or the Learning Style Composite could be displayed. In another embodiment, the Criteria Category Scores or the score of each Criterion Category could be displayed. In another embodiment, both the previous two embodiments could be combined.

In one embodiment of process operation 322, the student or user can see the scores (e.g. Criterion Category Scores) and learning styles (e.g., Learning Style Scores, Learning Style Composite, and/or Learning Style Categories) for each user inside each listed study room. The student or user can then choose the room that suits him or her given the scores of students within each study room. One skilled in the art will understand that a user may wish to join a room that has users holding best (or highest) scores or students with similar learning styles, Learning Style Categories, Learning Style Scores, and/or Learning Style Composites. However, one skilled in the art will also understand that a user may join a room based on the number of users in the room. For example, a user may wish to join a room with less than best scores if it has greater than a number of users or less than a number of users.

In this or another embodiment of process operation 322, the student can see Criterion Category Scores including, but not limited to, an aggregated Criterion Category Score or aggregated Criteria Category Scores. This aggregated score can be an average of the scores of the scorable or gradable criteria for each student or a one-score average that takes into account the criteria of the students currently within the study room. One skilled in the art will understand that this one-score average may be an average of a sub-group of criteria. In one embodiment, this one-score average may be an average of a sub-group of criteria. In addition, process operation 322 allows the student to also see the learning styles of each student. In another embodiment, the entire study room's Learning Style Category (or Categories) or Learning Style Composite(s) can be displayed as a one-score average. Control then transfers to operation 326.

In process operation 326, a student or user selects the study room he or she wants to join. This is also new and novel because the student chooses based on user-specific information, user-specific preferences, and/or perfect information (as a defined economics and/or game theory term) of the system/method rather than the system/method choosing or dictating the choice for the student. Control transfers to process operation 329.

In process operation 329, the student or user enters into the study room with other students or if no user is present in the virtual study room, a study room is created and this student is the first participant. In an embodiment, a virtual classroom or virtual conference room is created and the student enters as discussed in Multidimensional Virtual Learning System and Method (Non-Provisional patent application Number: U.S. patent application Ser. No. 14/460,575, filed Aug. 15, 2014). Control transfers to operation 330.

In process operation 330, the student or user studies together with other students and/or users and they help each other answer questions and/or learn the material. The student remains in the room for a period of time. Control then transfers to operation 340. In process operation 340, the student or user leaves the study room. This is most likely due to the choice of the student. However, the reason the student leaves the room could be any reason including, but not limited to, completed necessary studying, tired of studying for the time being, a poor internet connection, other I.T. issue, or due to expulsion by administrator, teacher, and/or other students could cause the student to leave the room. Also, the student or user who leaves the room is called the “Graded User.” Control then transfers to query operation 341.

In query operation 341, the system/method queries whether the Gamification Peer Review Function is enabled. If the answer is yes to query 341, then the flow of process operations moves to process operation 342. If the answer is no to query 341, then the method/system ends. In one embodiment, if the answer is yes to query 341, then the flow of operations would utilize the Gamification Peer Review Function as represented in FIG. 25 and discussed above. In another embodiment, if the answer is yes to query 341, then the flow of operations would utilize the Gamification Peer Review Function as represented in block 156 of FIG. 1 as discussed above.

In query operation 342, the system/method queries whether there are any students remaining in the room. If the answer is yes to query 342, then control, the flow of process, moves to process operation 350. If the answer is no to query 342, then the flow of this method/system moves to process operation 390 because the student or user has already scored, graded or answered criteria for all students.

In process operation 350, the remaining students or users in the room score, grade, and/or answer how the Graded User, i.e., the student or user who left the room, performed on a criterion. In another embodiment, the student can see each student on the Room List's learning style, Learning Style Composite, Learning Style Scores, and/or Learning Style Category. In another embodiment, students can grade other students on how well they performed per their learning style and whether the user's learning style is an accurate reflection in their opinions. The student or user being scored, graded or answered is referred to as the “Graded User.” A person skilled in the art understands there are many different terms that are synonyms and can also be used to describe a Graded User. One skilled in the art understands that there are any multitudes ways of articulating the concept of a Graded User and use of this term should not be construed as a limiting description; rather it is being used as an example to help illustrate this disclosure. Control then transfers to query operation 355.

In query 355, the system/method queries whether there is another criterion (e.g., a question involving a Criterion Category) to answer concerning the Graded User. If the answer is yes to query 355, then the flow of process moves back to process operation 350. If the answer is no to query 355, then control, i.e. the flow of this method/system moves to process operation 370. In process 370, a list of students or users who remain in the room is generated. This list is referred to as the Room List. Control transfers then to process operation 372.

In process 372, the student or user who left the room scores, grades, and/or answers how a student on the Room List performed on a criterion. The student being scored, graded, or answered is referred to as “Current Graded User.” A person skilled in the art understands there are many different terms that are synonyms and can also be used to describe a Current Graded User and the use of this term should not be seen as restrictive use, but rather illustratively. In another embodiment, the student can see each student's learning style, Criterion Category Scores, Learning Style Composite, Learning Style Scores, and/or Learning Style Category. In another embodiment, students can grade other students on how well they performed per their Learning Style Categories. Control then transfers to query operation 374.

In query 374, the system/method queries whether there is another criterion to be answered. If the answer is yes to query 374, then the flow of process moves back to process operation 372. If the answer is no to query 374, then control, the flow of this method/system, moves to process operation 376. In process operation 376, the Current Graded User's name is cleared as Graded User and Graded User value is blank or zero. Control then transfers to query operation 378.

In query 378, the system/method queries whether there is another student on the Room List. If the answer is yes to query 378, then the flow of process moves process operation 372 and clears the Current Graded User's name so the next student's name on the Room List can equal Current Graded User. If the answer is no to query 378, then the flow of this method/system moves to process operation 390.

In process 390, the system/method compiles the scoring, grading, or answer information of each student and creates statistics of each student who was graded, scored or answered. In one embodiment, the scores of criterions are improved or augmented by additional user information. In another embodiment, the scoring, grading, or answer information may update, refine or improve a Criteria Category, Learning Style Category, and/or Learning Style Score(s). An exemplary embodiment of this concept is shown in FIGS. 22, 23, and 24 and discussed below. FIGS. 22, 23, and 24 can be combined, but they do not need to be combined to facilitate process operations 180 and 190. Moreover, they can be used individually or in any combination. Control then transfers to process operation 395. In process operation 395, the system/method saves the information concerning each student's or user's scores for future reference, use, or display.

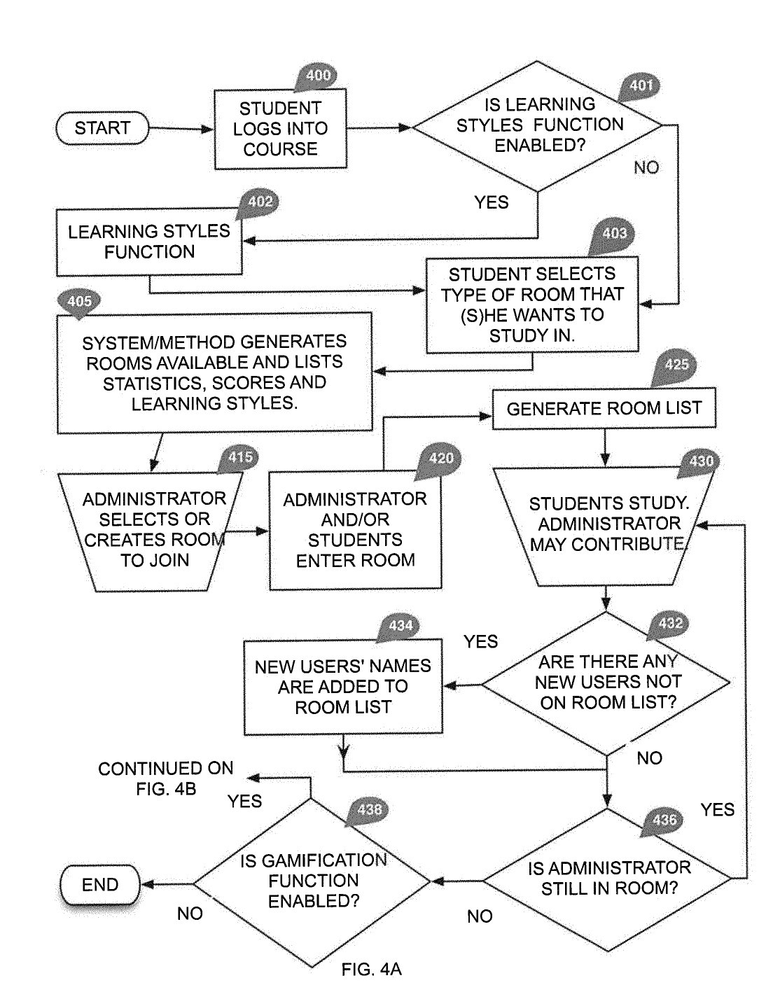

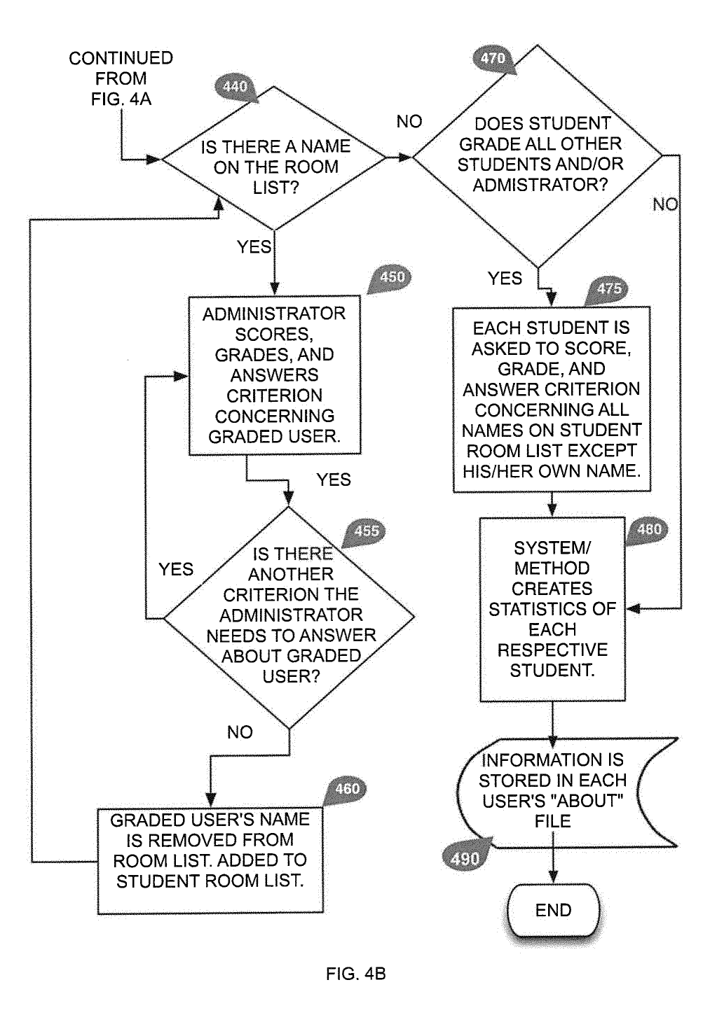

Another exemplary embodiment of a process/method of generating a virtual study room gamification system with learning styles is shown in the flow diagram of FIG. 4. The process begins in operation 400 in which a student or user logs into the online course, online conference, online classroom, system and/or method. Process control then transfers to query operation 401.

In query operation 401, the system/method queries whether the Learning Styles Function is enabled. While one embodiment will allow the administrator or professor to have the ability to enable or disable this function, other embodiments may allow any user (or other users in addition to a professor or administrator) to have the ability of enabling or disabling this function. If the answer is yes to query 401, then the flow of process operations moves to process operation 402. If the answer is no to query 401, then the flow of this method/system moves to process operation 403. In process operation 402, the system/method activates the Learning Style Function. An embodiment of this function is found in FIG. 5 and is also discussed in detail below. Process control then transfers to process operation 403.

In process operation 403, a student or user selects the type of room they will or wish to study in. This study room may be described by any criteria, including but not limited to, a chapter of a book, school program, cohort, study unit of an online course, a specific class, business segment, company division, company team, or any subject matter. This study room could be open to the public or a private room that requires invitation or a password. Moreover, this room could be a pre-set room created by a teacher or administrator. Control then transfers to operation 405.

In process operation 405 a list of rooms fitting the parameters the student chose is generated and displayed. In this generated list, the scores of the users inside these rooms are made available to the student.

In one embodiment of process operation 405, the administrator can see the scores (e.g., Criteria Category Scores and Learning Style Scores) for each user inside each listed study room. The administrator or user can then choose the room that bests suits him or her given the scores and/or learning styles of students within each study room. One skilled in the art will understand that a user may wish to join a room that has users holding best (or highest) scores or students with similar learning styles, Learning Style Categories, Learning Style Scores, and/or Learning Style Composites. However, one skilled in the art will also understand that a user may join a room based on the number of users in the room. Moreover, one skilled in the art will understand that the scoring system described in this paragraph can be reversed where the best score is the lowest score and the highest score is the worst score. In a system design constructed in this manner, the best score is the lowest score instead of being the highest score.

In one embodiment of process operation 405, the administrator or user can see an aggregated score and/or learning style for the study room. This aggregated score can be an average of the scores of all of the scorable or gradable criteria for each student or a one-score average that takes into account the criteria of the students currently within the study room. One skilled in the art will understand that this one-score average may be an average of a sub-group of criteria.

In one embodiment of process operation 405, the student can see a listing of administrators, professors, or tutors who have compatible or similar Learning Styles. The student can choose the course by professor with a desired learning style. In this manner, the students are able to pick the professors or tutors who also learn in a similar style. Moreover, by seeing other types of scores and learning styles, the student can pick not only the professor with the type of learning style the student enjoys, but also the student can pick the professor with the highest Criterion Category scores, which is an indication of teaching abilities. In this system/method, the teacher's data is obtaining new information and over time, the teacher's data should provide very good information concerning the teacher's learning style as well as teaching attributes or qualities. In economics and game theory this concept is referred to as having “perfect information”.

In process operation 405 a list of rooms fitting the parameters the administrator or user chose is generated. In this generated list, the scores of the users inside these rooms are made available to the student. In one embodiment, this generated list contains the scores of Criterion Categories (e.g., Criterion Category Scores), Learning Style Categories, scores of learning styles (e.g., Learning Style Scores), and statistics of the users inside these rooms are made available to the student. Examples include total score for both helpfulness and knowledge as well as average score per hour for helpfulness and knowledge. This could be listed for each user in the study room or in an overall condensed number taking into account each user in the room. Examples for Learning Styles are indications of students' dominant learning style and/or a breakdown of how each student is with respect to a specific learning style's scale. Examples of statistics include average time studying, length of time of progression in course, and other general relevant statistics. In one embodiment, the Learning Style Scores and/or the Learning Style Composite could be displayed. In another embodiment, the Criteria Category Scores or the score of each Criterion Category could be displayed. In another embodiment, both the previous two embodiments could be combined.

In one embodiment of process operation 405, the administrator or user can see Criterion Category Scores including, but not limited to, an aggregated Criterion Category Score or aggregated Criteria Category Scores. This aggregated score can be an average of the scores of the scorable or gradable criteria for each student or a one-score average that takes into account the criteria of the students currently within the study room. One skilled in the art will understand that this one-score average may be an average of a sub-group of criteria. In one embodiment, this one-score average may be an average of a sub-group of criteria. In another embodiment, process operation 405 allows the student to also see the learning styles of each student. In another embodiment, the entire study room's Learning Style can be displayed as a one-score average. In another embodiment, the Criterion Category Scores are displayed individually per user or as a combined score. Control then transfers to operation 415.

In process operation 415, an administrator selects the study room he or she wants to join. In an alternative embodiment of process operation 415, the administrator or user creates a room for students or users to join. Control then transfers to operation 420.

In process operation 420, the administrator enters into the study room with other students or if no user is present in the virtual study room, a study room is created and this administrator is the first participant. Students or users may enter into the room after the administrator is in the room. In another embodiment, students or users may enter into the room before the administrator. Control then transfers to operation 425.

In process operation 425, a list of users in study room is generated. This list is referred to as “Room List.” A person skilled in the art understands there are many different terms that are synonyms and can also be used to describe Room List. Control transfers to process operation 430.

In process operation 430, the administrator studies together with other students and/or users and they help each other answer questions and/or learn the material. The administrator remains in the room for a period of time. In another embodiment, the administrator monitors the students, but does not study with or help answer their questions. Control then transfers to query operation 432.

In query 432, the method/system queries whether there are any new users not on the Room List. If the answer is yes to query 432, then the flow of process moves to process operation 434. In process operation 434, the new user names are added to the Room List. If the answer is no to query 432, then the flow of this method/system moves to process query operation 436.

In query operation 436, the method/system queries whether the administrator remains in the room. If the answer is yes to query 436, then the flow of process moves to process 430 for a period of time. If the answer is no to query operation 436, then the flow of this method/system moves to query operation 438.

In query operation 438, the system/method queries whether the Gamification Peer Review Function is enabled. If the answer is yes to query 438, then the flow of process operations moves to process operation 440. If the answer is no to query 438, then the method/system ends. In one embodiment, if the answer is yes to query 438, then the flow of operations would utilize the Gamification Peer Review Function as represented in FIG. 25 and discussed above. In another embodiment, if the answer is yes to query 438, then the flow of operations would utilize the Gamification Peer Review Function as represented in block 156 of FIG. 1 as discussed above.

In query operation 440, the system/method queries whether there is a name on the Room List. If the answer is yes to query operation 440, then the flow of process moves to process operation 450. If the answer is no to query operation 440, then the flow of this method/system moves to process operation 470.

In process operation 450, the administrator, professor, or user scores, grades, and/or answers how a student or user, who is on the Room List, performed on a criterion. The student or user being scored, graded or answered is referred to as the “Graded User.” A person skilled in the art understands there are many different terms that are synonyms and can also be used to describe a Graded User. In another embodiment of operation 450, a criterion is listed and a list of student names is associated with this criterion. The administrator or professor scores, grades, or answers this criterion for all students. In another embodiment, the administrator or professor can grade students on how well they performed per their learning style (e.g., Learning Style Category, Learning Style Scores, and/or Learning Style Composite). This embodiment allows the system in process operation 480 to refine, augment, or improve each student's learning style (e.g., Learning Style Score) and/or Criterion Category/Categories. Control then transfers to query operation 455.

In query operation 455, the system/method queries whether there is another criterion or question to answer concerning the Graded User, who is listed on the Room List. If the answer is yes to query 455, then the flow of process moves to process operation 450. If the answer is no to query 455, then the flow of this method/system moves to process operation 460.

In process operation 460, the Graded User's name is removed from the Room List, but also added to “Student Room List.” This is a new list that will contain the list of names, at the option of the administrator or teacher, and will potentially be used to ensure each student grades each other. A person skilled in the art understands there are many different terms that are synonyms and can also be used to describe a Student Room List. Moreover, in process operation 460, the Graded User name is cleared so the value of Graded User is blank or zero and the name is not stored. After this process is complete, control of the system/method returns to query operation 440.

In query operation 470, the system/method queries whether there should also be student scoring, grading, or answering of information of each student. In an embodiment, the administrator is given the power to make this selection, which can be selected by administrator at any time. If the answer is yes to query 470, then the flow of process moves to process 475. If the answer is no to query 470, then the flow of process moves to process operation 480.

In process operation 475, each student or user scores, grades, and/or answers how another student or user, who is on the Student Room List, performed on a criterion. The student or user being scored, graded or answered is referred to as the “Graded User.” A person skilled in the art understands there are many different terms that are synonyms and can also be used to describe a Graded User. In this embodiment, a criterion is listed and a list of student names is associated with this criterion. The student scores, grades, or answers this criterion for all students. This embodiment allows the system in process operation 480 to refine, augment, or improve each student's learning style [e.g., Learning Style Score(s) or Learning Style Categories] and/or Criteria Category. In another embodiment, the student can see each student on the Student Room List's learning style, Criterion Category Score(s), Learning Style Composite, Learning Style Scores, and/or Learning Style Category. In another embodiment, students can grade other students on how well they performed per their learning style. This embodiment also allows the system in operation 480 to refine each student's Learning Style or Criterion Category. Control then transfers to process operation 480.

In process 480, the system/method compiles the scoring, grading, or answer information of each administrator, professor, student, and user and creates statistics of each student who was graded, scored or answered. In one embodiment, the scores of criterions are improved or augmented by additional user information. In another embodiment, the scoring, grading, or answer information may update, refine or improve a Criteria Category, Learning Style Category, and/or a Learning Style Score(s). An exemplary embodiment of this concept is shown in FIGS. 22, 23, and 24 and discussed below. FIGS. 22, 23, and 24 can be combined, but they do not need to be combined to facilitate process operation 480. Moreover, they can be used individually or in any combination. Control then transfers to process operation 490. In process 490, the system/method saves the information concerning each student's or user's scores for future reference, use, or display.

An exemplary embodiment of the Learning Styles Function is shown in the flow diagram of FIG. 5. The process begins by querying the user in query operation 503. In query operation 503, the system/method queries whether a student or user has completed a Learning Style Questionnaire. If the answer is yes to query 503, then the flow of process operations moves to process operation 509. If the answer is no to query 503, then the flow of this method/system moves to process operation 505.

In process operation 509, the system/method queries whether the user has data saved from the Gamification Method or Peer Review Gamification Method. If the answer to process operation 509 is no, control transfers to process operation 520. In process operation 520, the system/method recalls or retrieves the user's Learning Style Score and Learning Style Composite and the process ends. If the answer to process operation 509 is yes, then the system/method transfers control to process operation 516.

In process operation 516, the system/method retrieves the user's learning style and prior gamification scores. As discussed previously in process operations 190, 2590, 390, and 480, the system/method has embodiments that allow it to augment, refine, and improve prior Criteria Categories and/or learning styles (e.g., Learning Style Category and/or Learning Style Score(s)). In an embodiment, process operation 516, can recall the updated learning style of the student. In another embodiment, process operation 516 can recall the initial Learning Style Category, Learning Style Composite and/or Learning Style Score(s) and subsequent and iterative changes to the Learning Style Category, Learning Style Composite and/or Learning Style Score(s) based upon prior use of the system. If this latter embodiment is chosen, then the system transfers to operation 511. If the embodiment chosen already has the up-to-date learning styles that take into account all prior uses of the system/method, then the process will end.

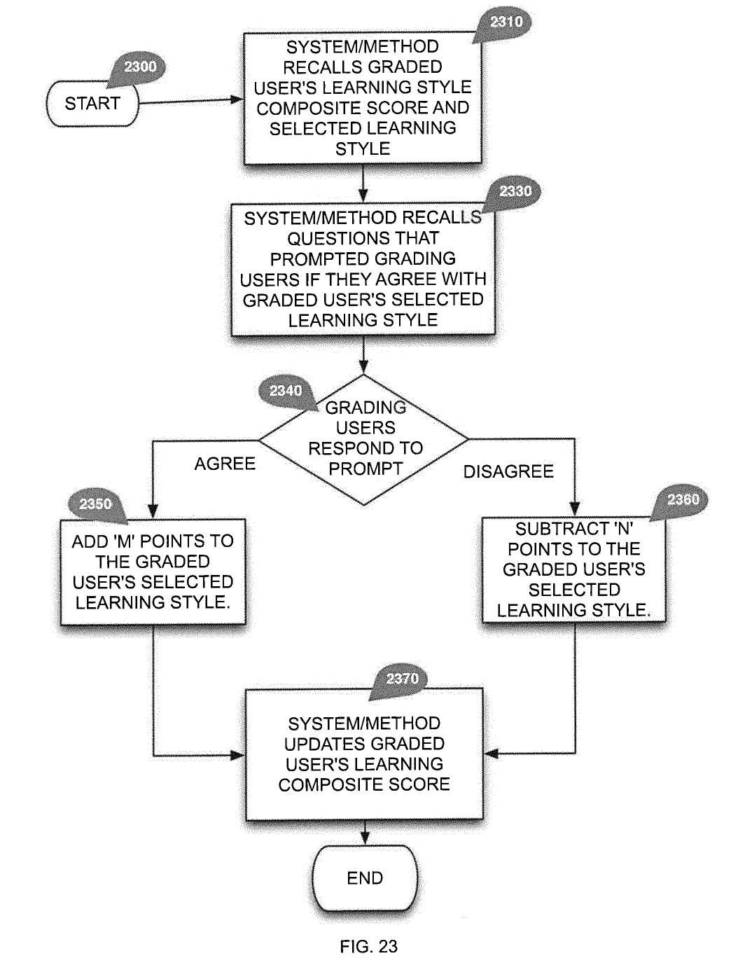

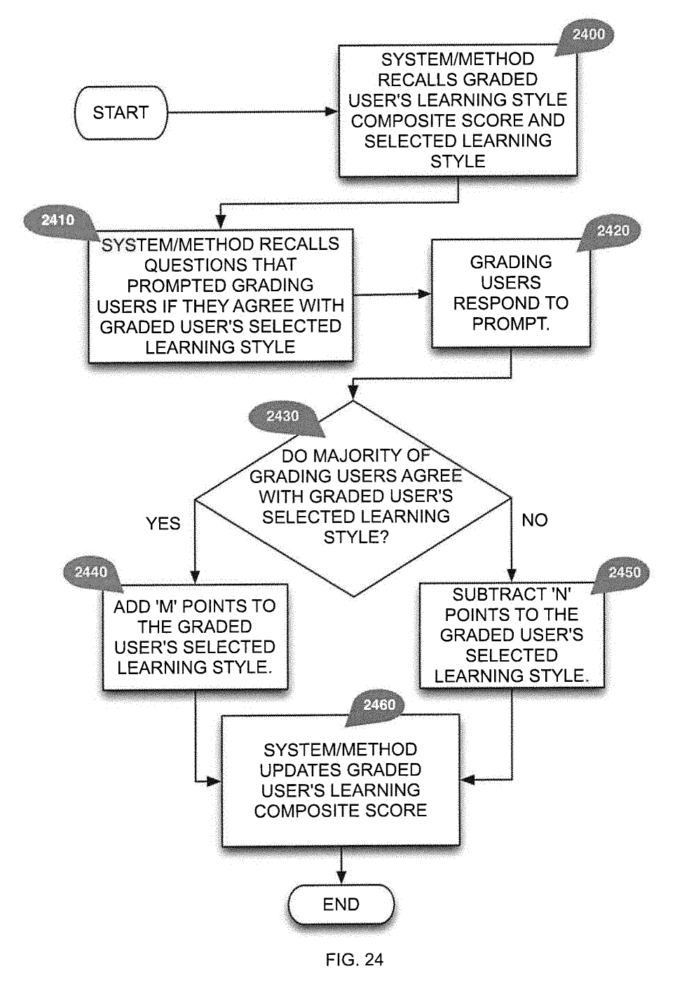

In process operation 511, the system/method updates the learning style. Exemplary embodiments of this concept is shown in FIGS. 23 and 24 and discussed below. FIGS. 23 and 24 can be combined, but they do not need to be combined to facilitate process operations 511. Moreover, they can be used individually or in combination.

In process operation 505, the system/method displays a screen explaining the benefits of taking a Learning Style Questionnaire. Process control then transfers to query operation 507. In query operation 507, the system/method queries whether the student or user wants to complete a Learning Style Questionnaire. If the answer is yes to query 507, then the flow of process operations moves to process operation 520. If the answer is no to query operation 507, then the flow of this function ends.

In process operation 520, the system/method provides a Learning Style Questionnaire to the user and the user completes the Learning Style Diagnostic Questions. This Learning Style Questionnaire could have any number of Learning Style Diagnostic Questions that users must grade themselves on. After the user completes the Learning Style Questionnaire, process control then transfers to process operation 512.

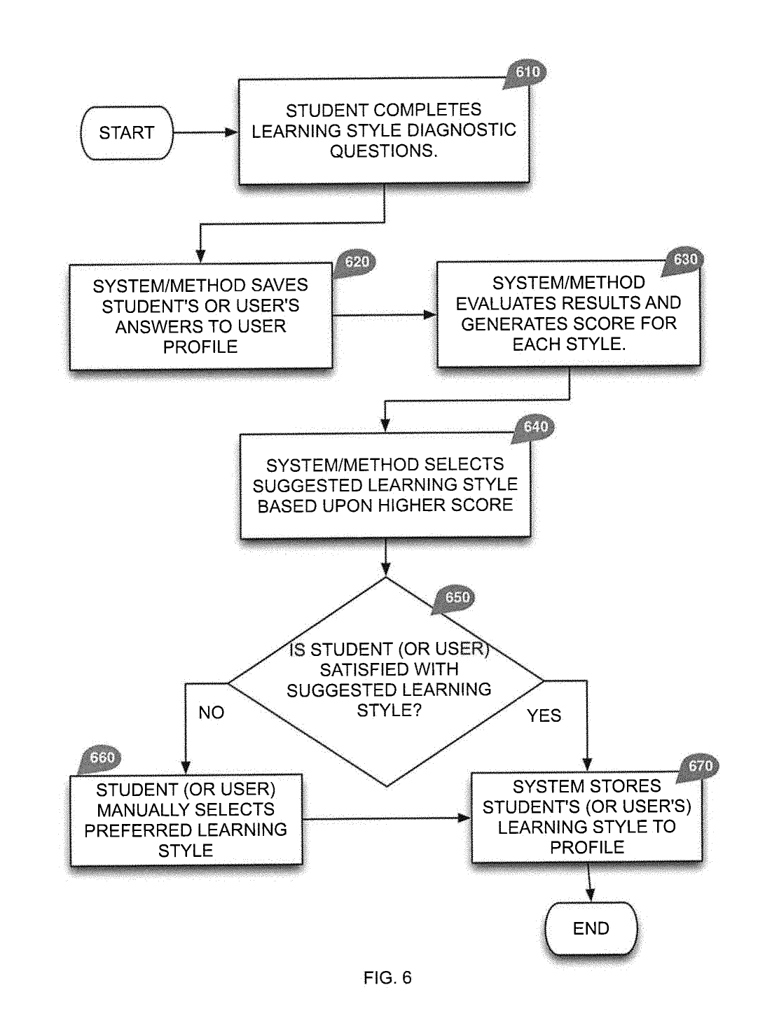

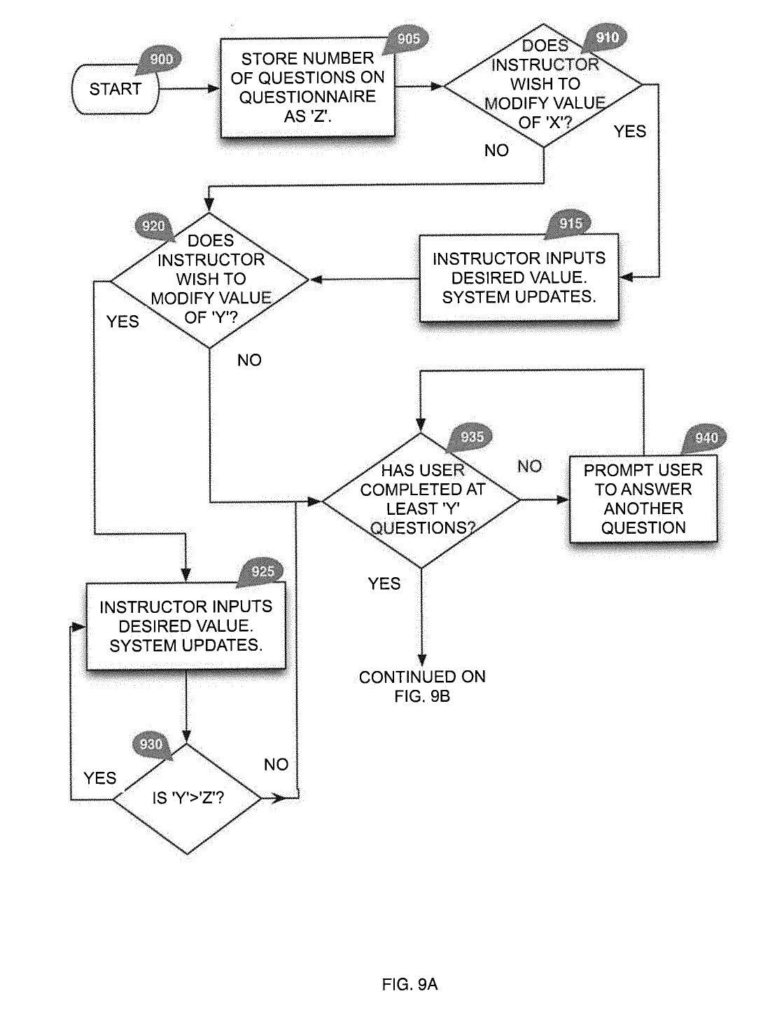

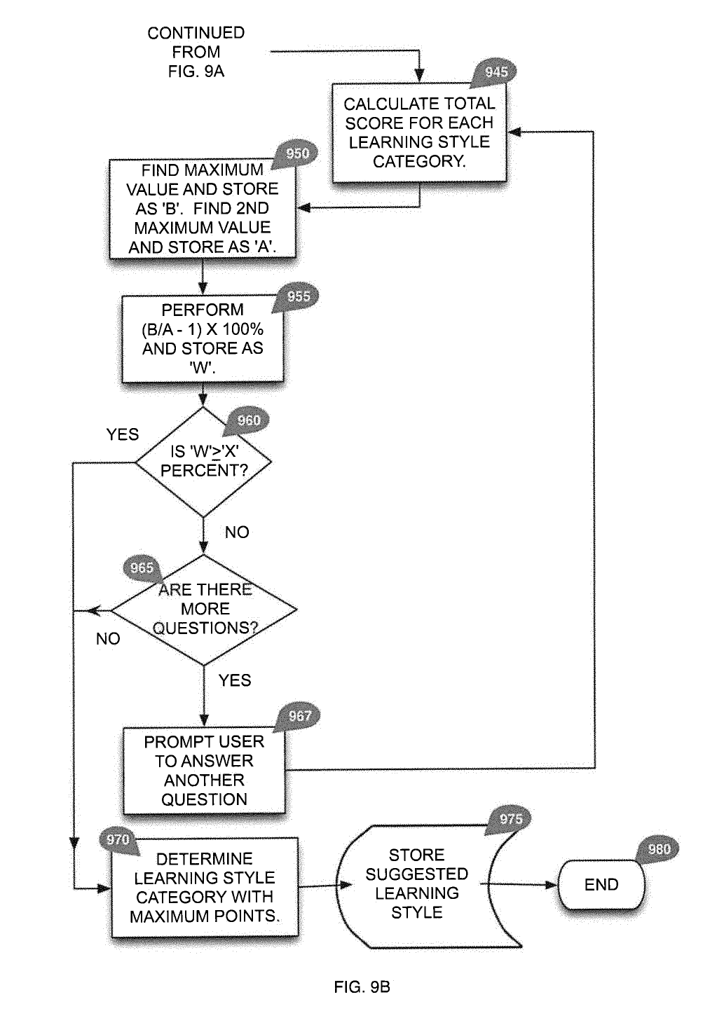

In process operation 512, the system/method generates the student's Learning Style Category by calculating the Learning style Scores and generating the Learning Style Composite. An embodiment of process operation 512 is described in FIG. 6 and discussed below. In another embodiment, process operation 512 could be operated in a manner consistent with FIG. 9 and discussed below. Process control then transfers to process storage 515.

In process storage 515, the system/method stores the user's Learning Style Questionnaire answers and scores. In another embodiment, process storage 515 stores only the user's Learning Style Questionnaire scores, such as the Learning Style Composite, Learning Style Category, and/or Learning Style Scores.

An exemplary embodiment of a process/method of determining a Learning Style based upon the results of a Questionnaire is shown in the flow diagram of FIG. 6. The process begins in operation 610 in which a student or user completes a Leaning Style Diagnostic Questionnaire. Control then transfers to process operation 620.

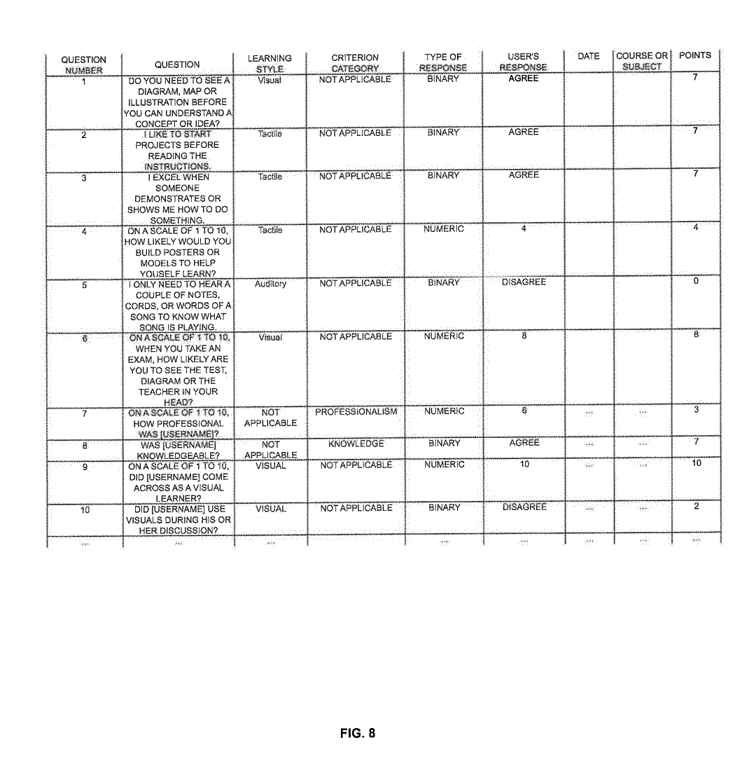

In process operation 620 the system/method saves the student's or user's responses to the Questionnaire to a database. An exemplary embodiment of this database can be found in FIG. 8. Control then transfer to process operation 630.

In process operation 630, the system/method evaluates the results and generates a Composite for each Learning Style. Control then transfers to operation 640.

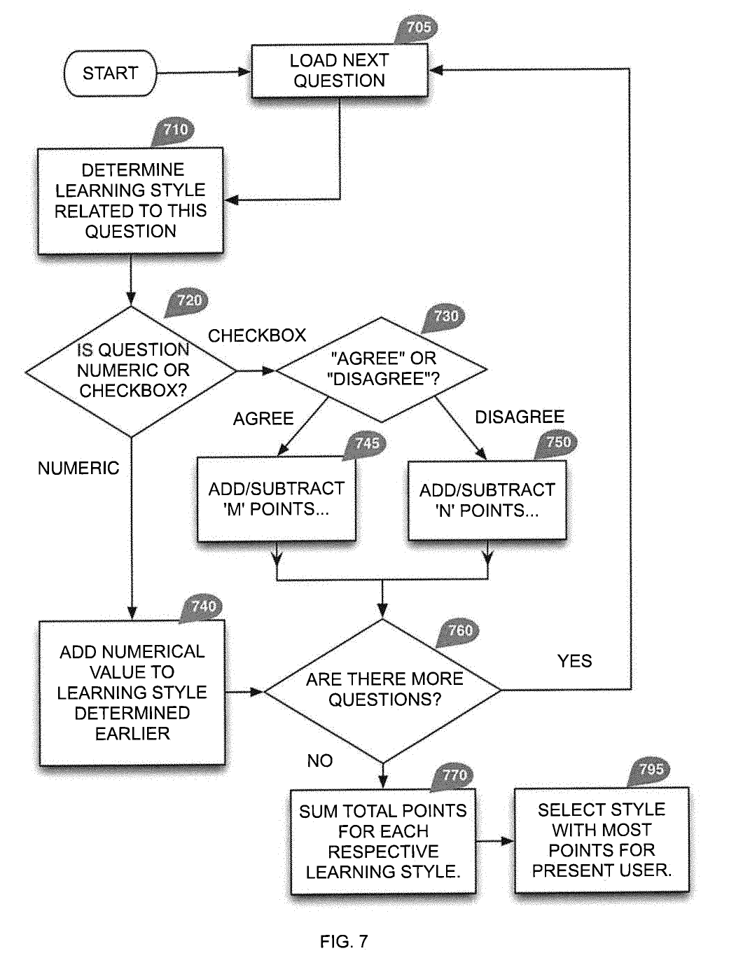

In process operation 640, the system/method selects the Learning Style with the best composite and displays the results to the student/user. An exemplary embodiment of process operation 640 is described below and can also be found in FIG. 7. Another embodiment of process operation 640 can be found in FIG. 9. Control then transfers to query operation 650.

In query operation 650, the system/method queries whether a student or user is satisfied with the Learning Style presented in operation 640. If the answer is yes to query 650, then the flow of process operations moves to process operation 670. If the answer is no to query 650, then the flow of this method/system moves to process 660. In another embodiment, query operation 650 is optional and at the discretion of the administrator or user. In this instance, control transfers from process operation 640 directly to process operation 670.

In process operation 660, the system/method displays a list of available Learning Styles and allows to user to select a preferred Learning Style. Control then transfers to process operation 670. In process operation 670, the system/method stores the student's Learning Style to a User Profile.

An exemplary embodiment of a process/method of evaluating a Learning Style Questionnaire and/or selecting a Learning Style is shown in the flow diagram of FIG. 7. This embodiment can be used as an embodiment of process operation 640. The process begins in operation 705 in which the system/method loads the next question for evaluation. Control then transfers to process operation 710.

In process operation 710 the system/method determines the Learning Style related to this question. In an embodiment, the system/method can determine this by referencing the database. An exemplary example of the database can be found in FIG. 8. Control then transfers to process operation 720.

In query operation 720, the system/method determines if the answer is binary (i.e. yes/no, checkbox, agree/disagree, etc.) or numeric. If the answer is binary to query 720 (e.g., checkbox as is shown in FIG. 7), then the flow of process operations moves to process operation 730. If the answer is numeric to query 720, then the flow of process operations moves to process operation 740.

In query operation 730, the system/method queries whether the user agreed or disagreed with the question loaded and answered. If the answer is determined to be ‘Agree’ to query 730, then the flow of process operations moves to process operation 740. IF the answer is determined to be Disagree′ to query 730, then the flow of process operations moves to process operation 745.

In process operation 740, the system/method adds the numerical value presented in operation 720 to the Learning Style category determined in operation 710.

In process operation 745 the system/method add or subtracts ‘M’ points to the Learning Style category determined in operation 710. It is to be understood that ‘M’ may represent any finite numerical value.

In process operation 750 the system/method add or subtracts ‘N’ points to the Learning Style category determined in operation 710. It is to be understood that ‘N’ may represent any finite numerical value.

In query operation 760, the system/method determines if there are more questions to be analyzed. If the answer is yes to query 760, then the flow of process operations moves to process operation 705. If the answer is no to query 760, then the flow of process operations moves to process operation 770.

In process operation 770 the system/method calculates the sum of the total points for each respective Learning Style Category. Control then transfers to process operation 795.

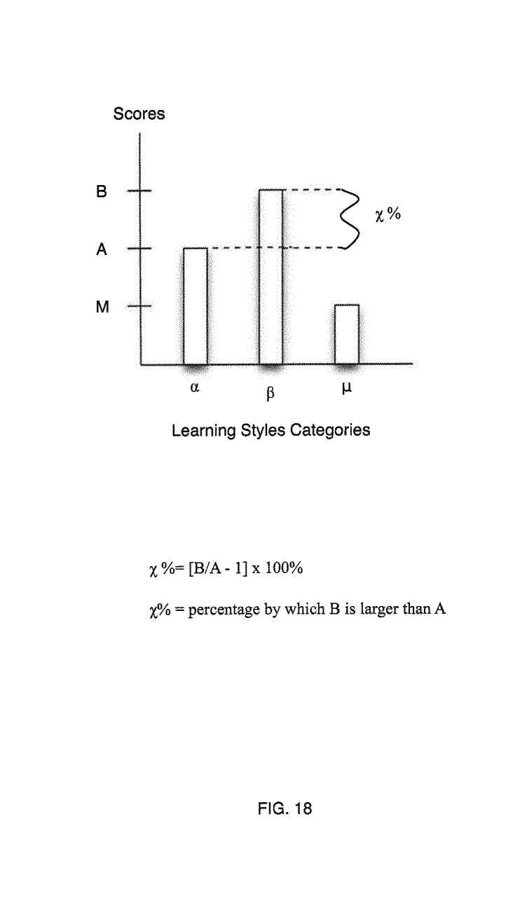

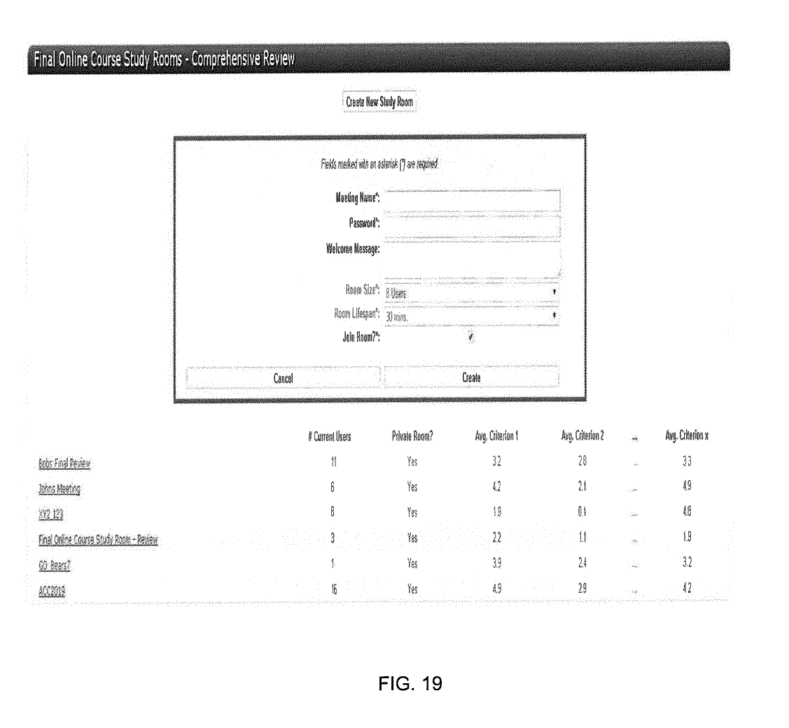

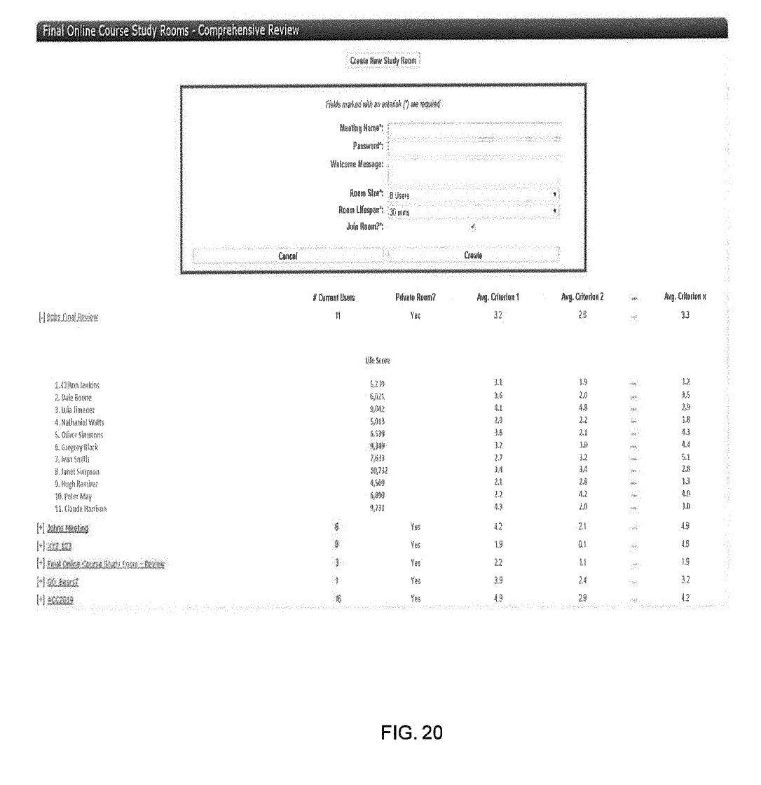

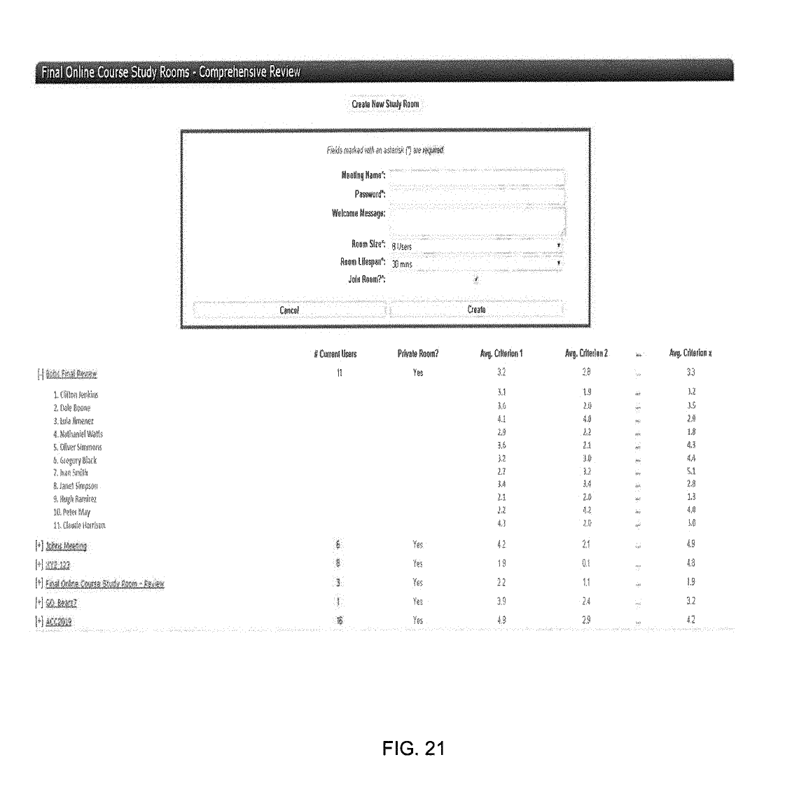

In process operation 795 the system/method selects the Learning Style category with the largest quantity of points. In one embodiment, the system/method utilizes a bar chart as depicted in FIG. 18 and displays the category with the highest quantity of points. In another embodiment, the system/method can average the points and express the results as a mixture of 2 and/or 3 types of learning styles. In this instance, a user could be labeled as an auditory-tactile learner or the user could be notified that they are a universal learner and have strong traits for all 3 types of learning styles: auditory, tactile, and visual.

FIG. 8 is an explanation of the method for storing responses to the Learning Style Questionnaire, and responses to both user's Learning Styles and Criterion Categories. A Learning Style Table may include, but not be limited to, the following categories: Question Number, Question, Learning Style Category, Criterion Category, Type of Response, User's Response, and Points. This method allows each question to be associated with a specific Learning Style Category or Criterion Category. The user's response is quantified and added as points to that Learning Style Category. In another embodiment, FIG. 8 can also include the different Criteria Categories and their respective Criteria Category Score(s).

An exemplary embodiment of a process/method of evaluating a Learning Style Questionnaire and determining a suggested Learning Style is shown in the flow diagram of FIG. 9. An embodiment of the process/method of FIG. 9 can be used as embodiments for both process operation 512 and process operation 640. The process begins in operation 905 in which the system/method saves/stores the total number of Questions on the Questionnaire. An exemplary example of operation 905 is saving/storing the integer quantity as some variable, ‘Z’. Control then transfers to query operation 910.

In query operation 910, the system/method prompts the administrator/instructor if they wish to modify the default value of ‘X’, where ‘X’ represents the percentage by which one Learning Style Score is larger than another. If the answer is yes to query 910, then the flow of process operations moves to process operation 915. If the answer is no to query 910, then the flow of process operations moves to query operation 920.

In process operation 915, the system/method prompts the administrator/teacher to input the desired value of ‘X’ and the system/method updates. Control then transfers to process operation 920.

In query operation 920, the system/method prompts the administrator/instructor if they wish to modify the default value of ‘Y’, where ‘Y’ represents the minimum number of Questions the student must answer before evaluation of Questionnaire begins. If the answer is yes to query 920, then the flow of process operations moves to process operation 925. If the answer is no to query 920, then the flow of process operations moves to query operation 935.

In process operation 925, the system/method prompts the administrator/teacher to input the desired value of ‘Y’ and the system/method updates. Control then transfers to query operation 930.

In query operation 930, the system/method evaluates the values of ‘Y’ and ‘Z’ and determines if ‘Y’ is greater than ‘Z’? If the answer is yes to query 930, then the flow of process operations moves back to process operation 925. If the answer is no to query 930, then the flow of process operations moves to query operation 935.

In query operation 935, the system/method determines if the user/student has completed at least ‘Y’ questions. If the answer is yes to query 935, then the flow of process operations moves to process operation 945. If the answer is no to query 935, then the flow of process operations moves to process operation 940.

In process operation 940, the system/method prompts the user/student to answer another Question from the Learning Style Questionnaire. Control then transfers back to process operation 935.

In process operation 945, the system/method calculates the total score for each Learning Style Category. Control then transfers to process operation 950.

In process operation 950, the system/method first determines the maximum value of Learning Style scores and stores the quantity as some variable ‘B’. The system/method then determines the next largest value of Learning Style scores and stores the quantity as some variable ‘A’. Control then transfers to process operation 955. In process operation 955, the system/method performs an algorithm to determine the actual percentage by which the Learning Style Category with the most points exceeds the Learning Style Category with the second-most points. The output value is stored as some variable, ‘W’. An embodiment of this is algorithm is [(B/A−1)*100%]. Control then transfers to query operation 960.

In query operation 960, the system/method evaluates the values of ‘W’ and ‘X’ and determines if ‘W’ is greater-than-or-equal-to ‘X’? If the answer is yes to query 960, then the flow of process operations moves to process operation 970. If the answer is no to query 960, then the flow of process operations moves to query operation 965.

In query operation 965, the system/method determines if there are more Questions from the Questionnaire to be evaluated. If the answer is yes to query 965, then the flow of process operations moves to process operation 967. If the answer is no to query 965, then the flow of process operations moves to process operation 970.

In process operation 967, the user is prompted to answer another Question and after the user answers the question, control transfers to process operation 945.

In process operation 970, the system/method determines the Learning Style Category with the largest quantity of points. Control then transfers to process operation 975. In process operation 975, the system/method stores/saves the suggested Learning Style. Control then transfers to process end operation 980.

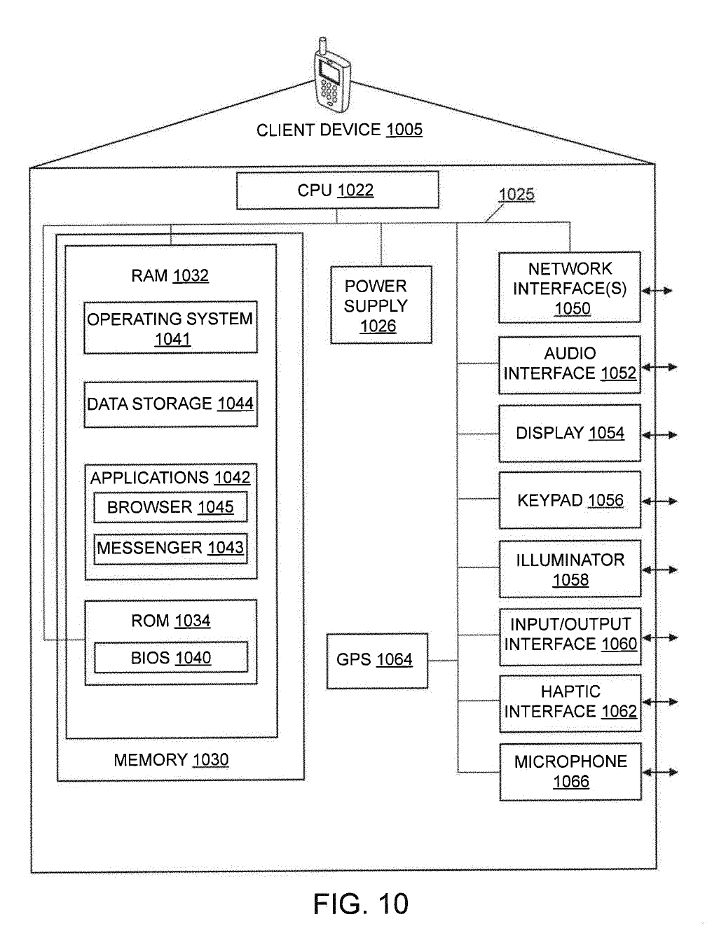

FIG. 10 shows one example of a schematic diagram illustrating a client device 1005 upon which an exemplary embodiment of the present disclosure may be implemented. Client device 1005 may include a computing device capable of sending or receiving signals, such as via a wired or wireless network. A client device 1005 may, for example, include a desktop computer, a tablet computer, or a laptop computer, with a digital camera. The client device 1005 may vary in terms of capabilities or features. Shown capabilities are merely exemplary.

Client device 1005 may include one or more processing units (also referred to herein as CPUs) 1022, which interface with at least one computer bus. A memory 1030 can be persistent storage and interfaces with the computer bus. The memory 1030 includes RAM 1032 and ROM 1034. ROM 1034 includes a BIOS 1040. Memory 1030 interfaces with the computer bus so as to provide information stored in memory 1030 to CPU 1022 during execution of software programs such as an operating system 1041, application programs 1042 such as device drivers (not shown), and software messenger module 1043 and browser module 1045, that comprise program code, and/or computer-executable process steps, incorporating functionality described herein, e.g., one or more of process flows described herein. CPU 1022 first loads computer-executable process steps from storage, e.g., memory 1032, data storage medium/media 1044, removable media drive, and/or other storage device. CPU 1022 can then execute the stored process steps in order to execute the loaded computer-executable process steps. Data storage medium/media 1044 is a computer readable storage medium(s) that can be used to store software and data and one or more application programs. Persistent storage medium/media 1044 can also be used to store device drivers, such as one or more of a digital camera driver, monitor driver, printer driver, scanner driver, or other device drivers, web pages, content files, playlists and other files. Client device 1005 also preferably includes one or more of a power supply 1026, network interface 1050, audio interface 1052, a display 1054 (e.g., a monitor or screen), keypad 1056, an input device such as an illuminator 1058, imaging device e.g. a camera, I/O interface 1020, a haptic interface 1062, a GPS 1064, and/or a microphone 1066.

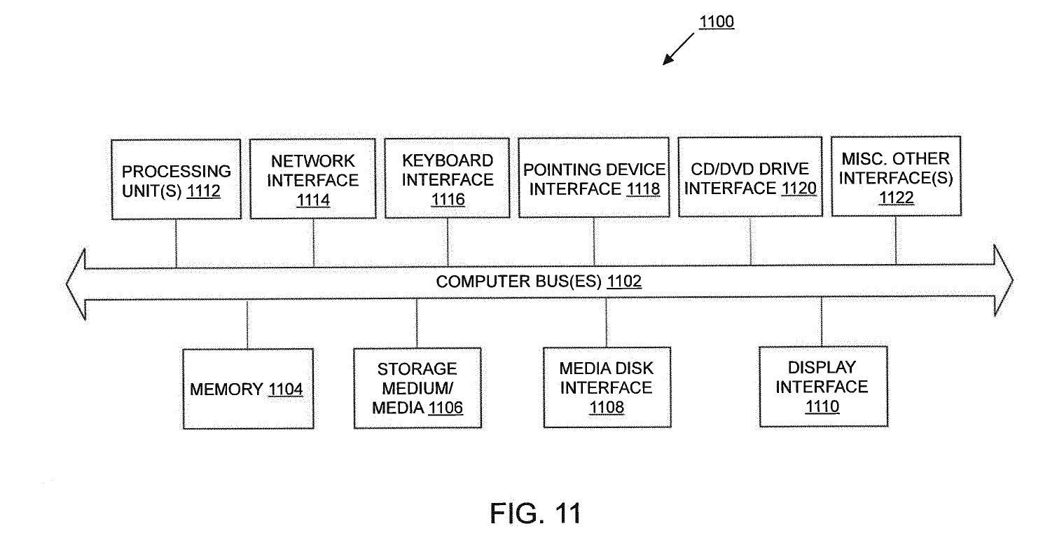

FIG. 11 is a block diagram illustrating an internal architecture 1100 of an example of a computer, such as server computer and/or client device, utilized in accordance with one or more embodiments of the present disclosure. Internal architecture 1100 includes one or more processing units (also referred to herein as CPUs) 1112, which interface with at least one computer bus 1102. Also interfacing with computer bus 1102 are persistent storage medium/media 1106, network interface 1114, memory 1104, e.g., random access memory (RAM), run-time transient memory, read only memory (ROM), etc., media disk drive interface 1108 as an interface for a drive that can read and/or write to media including removable media such as floppy, CD-ROM, DVD, etc. media, display interface 1110 as interface for a monitor or other display device, keyboard interface 1116 as interface for a keyboard, pointing device interface 1118 as an interface for a mouse or other pointing device, CD/DVD drive interface 1120, and miscellaneous other interfaces 1122, such as a camera interface, parallel and serial port interfaces, a universal serial bus (USB) interface, Apple's ThunderBolt and Firewire port interfaces, and the like.

Memory 1104 interfaces with computer bus 1102 so as to provide information stored in memory 1104 to CPU 1112 during execution of software programs such as an operating system, application programs, device drivers, and software modules that comprise program code, and/or computer-executable process steps, incorporating functionality described herein, e.g., one or more of process flows described herein. CPU 1112 first loads computer-executable process steps from storage, e.g., memory 1104, storage medium/media 1106, removable media drive, and/or other storage device. CPU 1112 can then execute the stored process steps in order to execute the loaded computer-executable process steps. Stored data, e.g., data stored by a storage device, can be accessed by CPU 1112 during the execution of computer-executable process steps.

As described above, persistent storage medium/media 1106 is a computer readable storage medium(s) that can be used to store software and data, e.g., an operating system and one or more application programs. Persistent storage medium/media 1106 can also be used to store device drivers, such as one or more of a digital camera driver, monitor driver, printer driver, scanner driver, or other device drivers, web pages, content files, playlists and other files. Persistent storage medium/media 1106 can further include program modules and data files used to implement one or more embodiments of the present disclosure.

An exemplary embodiment of a system/method of a process gathering multiple peer feedback of a user's Criteria Categories is shown in the flow diagram of FIG. 22. FIG. 22 is an exemplary embodiment for how process operations 180, 190, 390, 480, and 2590 obtain the information from other users to refine, augment, and improve the Criterion Category Scores after each time a user studies in a study room. This process begins in process operation 2205 where the system loads the (next) question that other users have already answered concerning user. In another embodiment, process operation 2205 provides the question to the user, and the user answers the question. Control then transfers to process operation 2210.

In process operation 2210, the system/method determines the Criterion Category related to this specific question. In an embodiment, the system/method can determine this by referencing the database. An exemplary example of the database can be found in FIG. 8. In another embodiment, process operation 2210 could be combined with process operation 2205, so when the question is pulled from the database, the system/method could simultaneously determine the Criterion Category related to the respective question. In another embodiment, process operation 2210, could come immediately after process operation 2220 and/or process operation 2230 as long as process operation 2210 occurs before process operations 2240, 2245, and 2250. Control then transfers to query operation 2220.

In query operation 2220, the system/method determines if the question is binary (i.e. yes/no, checkbox, agree/disagree, etc.) or numeric. If the answer to query 2220 is binary (e.g., ‘checkbox’ as shown in FIG. 22), then the flow of process operations moves to process operation 2230. If the answer to query 2220 is numeric, then the flow of process operations moves to process operation 2240.

In process operation 2240, the system/method adds the numerical value presented in operation 2220 to the Criterion Category Score determined in operation 2210. In one embodiment, process operation could be combined with process operation 2270. In another embodiment, the numerical values of the numeric questions are added the respective Criterion Category Score. These numerical values could be raw numerical values or an average per user score. For example if there were 3 other users who grade one particular user and they each provided 4, 8, and 9 for the Criterion Category “Reliable” for this one particular user, then the system/method could update the particular user's “Reliable” Criterion Category by 21 or 7 because 7 is the average score per grading user.

In query operation 2230, the system/method queries whether the user agreed or disagreed with the question loaded and answered in process operation 2205. If the answer is “Agree” to query 2230, then the flow of process operations moves to process operation 2245. If the answer is “Disagree” to query 2230, then the flow of process operations moves to process operation 2250.

In process operation 2245, the system/method adds ‘m’ points to the user's respective Criterion Category Score. It is to be understood that ‘m’ can represent any finite number. Control then transfers to query operation 2260.

In process operation 2250, the system/method subtracts ‘n’ points from the user's respective Criterion Category Score. It is to be understood that ‘n’ can represent any finite number. Control then transfers to process operation 2360.

In query operation 2260, the system/method queries whether there are more questions. If the answer to query operation 2260 is yes, then the control transfers to process operation 2205. If the answer to query operation 2260 is no, then control transfers to process operation 2270.

In process operation 2270, the system/method updates the user's Criteria Category Scores. In one embodiment, the ‘m’ and ‘n’ scores are netted against each other and then either added (if the ‘m’ scores are higher than the ‘n’ scores) or subtracted (if the ‘n’ scores are higher than the ‘m’ scores). In this instance the respective Criterion Category Score is increased or decreased based upon how the collective group feels concerning their interaction with the user. In another embodiment, the numerical values of the numeric questions are added the respective Criterion Category Score. These numerical values could be raw numerical values or an average per user score. For example if there were 3 other users who grade one particular user and they each provided 4, 8, and 9 for the “Congenial” Criterion Category for this one particular user, then the system/method could update the particular user's Congenial Criteria Category by 21 or 7 because 7 is the average score per grading user. In another embodiment, it could combine both the former and latter embodiments.

An exemplary embodiment of a system/method of a process gathering multiple peer feedback of a User's selected Learning Style is shown in the flow diagram of FIG. 23. FIG. 23 is an exemplary embodiment for how process operations 180, 190, 390, 480, and 2590 obtain the information from other users to refine, augment, and improve the Learning Style Score after each time a user studies in a study room. The process begins in operation 2300 in which the system/method begins. Control immediately transfers to process operation 2310.

In process operation 2310, the system/method loads the Graded User's Learning Style Composite Score and the Graded User's selected Learning Style. Control then transfers to process operation 2330.

In process operation 2330, the system/method loads the Graded User's question that prompted the Grading Users if they agree with the Graded User's selected Learning Style. In another embodiment, process operation 2330 prompts the Grading Users if they agree with the Graded User's selected Learning Style. Control then transfers to query operation 2340.

In query operation 2340, the Grading User determines whether he or she agrees with the graded user's selected learning style. If the answer is “Agree” to query 2340, then the flow of process operations moves to process operation 2350. If the answer is “Disagree” to query 2340, then the flow of process operations moves to process operation 2360.

In process operation 2350, the system/method adds ‘m’ points to the Graded User's selected Learning Style on the Graded User's Learning Style Composite. It is to be understood that ‘m’ can represent any finite number. Control then transfers to process operation 2370.

In process operation 2360, the system/method subtracts ‘n’ points from the Graded User's selected Learning Style on the Graded User's Learning Style Composite. It is to be understood that ‘n’ can represent any finite number. Control then transfers to process operation 2370.

In process operation 2370, the system/method updates the Graded User's Learning Style Composite Score and/or the Learning Style Score(s). In one embodiment, the ‘m’ and ‘n’ scores are netted against each other and then either added (if the ‘m’ scores are higher than the ‘n’ scores) or subtracted (if the ‘n’ scores are higher than the ‘m’ scores). In this instance the Learning Style Composite and/or the Learning Style Score(s) are increased or decreased based upon how the collective group feels concerning their interaction with the user.

An exemplary embodiment of a process/method of gathering multiple peer feedback of a User's selected Learning Style is shown in the flow diagram of FIG. 24. FIG. 24 is an exemplary embodiment for how process operations 180, 190, 390, 480, and 2590 obtain the information from other users to refine, augment, and improve the Learning Style Score after each time a user studies in a study room. The process begins in operation 2400 the system/method loads the Graded User's Learning Style Composite Score and the Graded User's selected Learning Style. Control then transfers to process operation 2410.

In process operation 2410, the system/method recalls the Graded User's question that prompted the Grading Users if they agree with the Graded User's selected Learning Style. In another embodiment, process operation 2410 prompts the Grading Users if they agree with the Graded User's selected Learning Style. Control then transfers to process operation 2420.

In process operation 2420, the system/method stores the responses of the Grading Users as they respond to the prompt. In another embodiment, process operation 2420 is unnecessary if the Grading Users have already answered the question and the answers were recalled in process operation 2410. Control then transfers to query operation 2430.

In query operation 2430, the system/method determines if the majority of Grading Users agree with the Graded User's selected Learning Style. If the answer is determined to be ‘Agree’ to query 2430, then the flow of process operations moves to process operation 2440. If the answer is determined to be ‘Disagree’ to query 2430, then the flow of process operations moves to process operation 2450.

In process operation 2440, the system/method adds ‘m’ points to the Graded User's selected Learning Style on the Graded User's Learning Style Composite. It is to be understood that ‘m’ can represent any finite number. Control then transfers to process operation 2460.

In process operation 2450, the system/method subtracts ‘n’ points to the Graded User's selected Learning Style on the Graded User's Learning Style Composite. It is to be understood that ‘n’ can represent any finite number. Control then transfers to process operation 2460.

In process operation 2460, the system/method updates the Graded User's Learning Style Composite Score and/or the Learning Style Score(s). In one embodiment, the ‘m’ and ‘n’ scores are netted against each other and then either added (if the ‘m’ scores are higher than the ‘n’ scores) or subtracted (if the ‘n’ scores are higher than the ‘m’ scores). In this instance the Learning Style Composite and/or the Learning Style Score(s) are increased or decreased based upon how the collective group feels concerning their interaction with the user.

From this description, it will be appreciated that certain aspects are embodied in the user or client devices, certain aspects are embodied in the server systems, and certain aspects are embodied in a system as a whole. Embodiments disclosed can be implemented using hardware, programs of instruction, or combinations of hardware and programs of instructions.

In general, routines executed to implement the embodiments may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects.

While some embodiments have been described in the context of fully functioning computers and computer systems, those skilled in the art will appreciate that various embodiments are capable of being distributed as a program product in a variety of forms and are capable of being applied regardless of the particular type of machine or computer-readable media used to actually effect the distribution.

Examples of computer-readable media include but are not limited to recordable and non-recordable type media such as volatile and non-volatile memory devices, read only memory (ROM), or random access memory. In this description, various functions and operations are described as being performed by or caused by software code to simplify description. However, those skilled in the art will recognize what is meant by such expressions is that the functions result from execution of the code by a processor, such as a microprocessor.

It will be apparent, however, to one skilled in the art that the invention can be practiced without these specific details. In other instances, structures and devices are shown in block diagram form in order to avoid obscuring the description.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

Although the disclosure has been provided with reference to specific exemplary embodiments, it will be evident that the various modification and changes can be made to these embodiments without departing from the broader spirit as set forth in the claims. Accordingly, the specification and drawings are to be regarded in an illustrative sense rather than in a restrictive sense.

All such changes, alternatives and equivalents in accordance with the features and benefits described herein, are within the scope of the present disclosure. Such changes and alternatives may be introduced without departing from the spirit and broad scope of my invention as defined by the claims below and their equivalents.

What is claimed is:

1. A method comprising:
receiving, at a computing device, a request from a device of a user to access a computerized online classroom task, said task comprising an interactive online experience provided by the computing device over a network;
initiating, via the computing device, said online task based on said request, said initiating comprising executing files associated with the online task such that data associated with the online task is communicated to the user device over the network, said communication causing the online task to begin execution such that the interactive online experience runs for a predetermined period of time, said communication further causing a user interface (UI) to be displayed on a display of the user device that displays an interactive display of plurality of virtual student classrooms;
receiving, at the computing device, a selection of at least one of the plurality of virtual student classrooms displayed within the UI;
communicating, based on the received selection, information associated with students within the selected virtual student classroom along with the user, said communication of the information causing the UI to be updated with a display of said student information;
monitoring, via the computing device, user and student interactions within the virtual student classroom during the interactive online experience, said monitoring comprising analyzing said user and student interactions as they are received, and based on said analysis, determining, via the computing device, a preferred learning style for the user and each student in the virtual student classroom, said determination performed in accordance with a computerized learning styles questionnaire presented to the user and each student in the virtual student classroom during the interactive online experience; and
automatically computer grading, via the computing device, the user and each student in the virtual student classroom according to predetermined performance criteria, said criteria comprising data associated with levels of helpfulness, maturity, professionalism and knowledge.

2. A computing device comprising:
a processor;
a non-transitory computer-readable storage medium for tangibly storing thereon program logic for execution by the processor, the program logic comprising:
logic executed by the processor for receiving, at the computing device, a request from a device of a user to access a computerized online classroom task, said task comprising an interactive online experience provided by the computing device over a network;
logic executed by the processor for initiating, via the computing device, said online task based on said request, said initiating comprising executing files associated with the online task such that data associated with the online task is communicated to the user device over the network, said communication causing the online task to begin execution such that the interactive online experience runs for a predetermined period of time, said communication further causing a user interface (UI) to be displayed on a display of the user device that displays an interactive display of plurality of virtual student classrooms;
logic executed by the processor for receiving, at the computing device, a selection of at least one of the plurality of virtual student classrooms displayed within the UI;
logic executed by the processor for communicating, based on the received selection, information associated with students within the selected virtual student classroom along with the user, said communication of the information causing the UI to be updated with a display of said student information;
logic executed by the processor for monitoring, via the computing device, user and student interactions within the virtual student classroom during the interactive online experience, said monitoring comprising analyzing said user and student interactions as they are received, and based on said analysis,
determining, via the computing device, a preferred learning style for the user and each student in the virtual student classroom, said determination performed in accordance with a computerized learning styles questionnaire presented to the user and each student in the virtual student classroom during the interactive online experience; and
logic executed by the processor for automatically computer grading, via the computing device, the user and each student in the virtual student classroom according to predetermined performance criteria, said criteria comprising data associated with levels of helpfulness, maturity, professionalism and knowledge

3. A non-transitory computer-readable storage medium tangibly encoded with computer-executable instructions, that when executed by a processor associated with a computing device, performs a method comprising:
receiving, at the computing device, a request from a device of a user to access a computerized online classroom task, said task comprising an interactive online experience provided by the computing device over a network;
initiating, via the computing device, said online task based on said request, said initiating comprising executing files associated with the online task such that data associated with the online task is communicated to the user device over the network, said communication causing the online task to begin execution such that the interactive online experience runs for a predetermined period of time, said communication further causing a user interface (UI) to be displayed on a display of the user device that displays an interactive display of plurality of virtual student classrooms;
receiving, at the computing device, a selection of at least one of the plurality of virtual student classrooms displayed within the UI;
communicating, based on the received selection, information associated with students within the selected virtual student classroom along with the user, said communication of the information causing the UI to be updated with a display of said student information;
monitoring, via the computing device, user and student interactions within the virtual student classroom during the interactive online experience, said monitoring comprising analyzing said user and student interactions as they are received, and based on said analysis, determining, via the computing device, a preferred learning style for the user and each student in the virtual student classroom, said determination performed in accordance with a computerized learning styles questionnaire presented to the user and each student in the virtual student classroom during the interactive online experience; and
automatically computer grading, via the computing device, the user and each student in the virtual student classroom according to predetermined performance criteria, said criteria comprising data associated with levels of helpfulness, maturity, professionalism and knowledge
